(19) United States
(12) Patent Application Publication
(10) Pub. No.: US 2025/0175710 A1
(43) Pub. Date: May 29, 2025

(54) STRAY LIGHT REDUCTION IN EYE/FACE TRACKING SYSTEMS

(71) Applicant: Meta Platforms Technologies, LLC, Menlo Park, CA (US)

(72) Inventors: Mantas Zurauskas, Redmond, WA (US); Robert Dale Cavin, Bellevue, WA (US)

(73) Assignee: Meta Platforms Technologies, LLC, Menlo Park, CA (US)

(21) Appl. No.: 18/952,477

(22) Filed: Nov. 19, 2024

Related U.S. Application Data
(60) Provisional application No. 63/603,983, filed on Nov. 29, 2023.

(51) Int. Cl. H04N 23/72; G02B 5/20; G02B 27/01; G06F 3/01; H04N 23/21; H04N 23/71; H04N 23/74; H04N 23/75

(52) U.S. Cl. CPC H04N 23/72; G02B 27/0179; G06F 3/012; G06F 3/013; H04N 23/21; H04N 23/71; H04N 23/74; H04N 23/75; G02B 5/208; G02B 2027/0187

(57) ABSTRACT

Systems, methods, and apparatuses to reduce stray light in eye/face tracking systems of near-eye devices are presented. In one aspect, an IR filter may minimize stray light when suitably disposed in-frame, in-lens (as, e.g., a localized in-lens IR filter), and/or coupled to a waveguide. In another aspect, configurations of linearly-polarized IR light sources and polarization-sensitive IR light sensors may be effective for stray light reduction in eye/face tracking systems. In yet another aspect, polarization-sensitive pre-processing methods and/or stray light reduction methods may be beneficial for eye/face tracking systems in near-eye devices. In an example, a near-eye AR/VR device includes a display screen to display AR/VR content through an optical stack, which includes a light source to project linearly-polarized IR light onto the user's eye, and a polarization-sensitive IR light sensor filters received IR light using polarization to separate out stray light from the linearly-polarized eye/face tracking light.

### CROSS-REFERENCE TO OTHER APPLICATIONS

This application claims priority under 35 U.S.C. § 119 to U.S. Prov. Pat. App. Ser. No. 63/603,983 entitled STRAY LIGHT REDUCTION IN EYE TRACKING SYSTEMS and filed on Nov. 29, 2023, the entire contents of which are incorporated herein by reference.

### TECHNICAL FIELD

This patent application relates generally to stray light reduction in the eye/face tracking systems of near-eye devices, and in particular, to stray light reduction through various filter configurations and the use of controlled polarization a near-eye device which may be particularly useful in AR/VR eye/face tracking systems.

### BACKGROUND

With recent advances in technology, prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, service providers have endeavored to provide various forms of wearable display systems. One such example may be a head-mounted display (HMD) device, such as a wearable eyewear, a wearable headset, or eyeglasses. In some examples, the head-mounted display (HMD) device may project or direct light to may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment. Head-mounted display (HMD) devices may also present interactive content, where a user's (wearer's) gaze may be used as input for the interactive content.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display, according to an example.

FIGS. 2A-2C illustrate various views of a near-eye display device in the form of a head-mounted display (HMD) device, according to examples.

FIG. 3 illustrates a perspective view of a near-eye display device in the form of a pair of glasses, according to an example.

FIGS. 4A, 4B, and 4C illustrate an in-frame infrared (IR) filter configuration (with in-frame camera), a localized in-lens IR filter configuration (with an in-lens camera), and a waveguide IR filter configuration (where the camera is coupled to the waveguide), respectively, for a near-eye device, according to various examples of the present disclosure.

FIG. 5 is a graphic illustrating the relationship between optical density and wavelength for an IR cut-filter which may be used for stray light mitigation in a near-eye device, according to an example of the present disclosure.

FIG. 6 is a block diagram illustrating a configuration of linearly-polarized eye/face tracking IR light sources for illuminating an eye and a polarization-sensitive eye/face tracking IR sensor for receiving reflections of the linearly-polarized IR light from the eye, according to an example of the present disclosure.

FIG. 7 is a block diagram illustrating a configuration of linearly-polarized eye/face tracking IR light sources for illuminating an eye and an eye/face tracking grayscale camera fitted with a linear polarization filter for receiving reflections of the linearly-polarized IR light from the eye, according to an example of the present disclosure.

FIG. 8 is a block diagram illustrating a configuration of linearly-polarized eye/face tracking IR light sources and a polarization-sensitive eye/face tracking IR sensor in an optical stack which may contain one or more optical retarders, according to an example of the present disclosure.

FIG. 9 is a block diagram illustrating a configuration of linearly-polarized eye/face tracking IR light sources and a polarization-sensitive eye/face tracking IR sensor, which is fitted with an active polarization rotator for receiving reflections of the linearly-polarized light from the eye, according to an example of the present disclosure.

FIG. 10A is a block diagram illustrating a configuration of pulsed time of flight (ToF) eye/face tracking IR light sources for illuminating an eye and a ToF eye/face tracking IR sensor for receiving reflections of the pulsed IR light from the eye, according to an example of the present disclosure.

FIG. 10B is a graphic of detected photons (by a configuration such as shown in FIG. 10A) over time, indicating the time-gated period suitable for isolating IR reflections from the eye, according to an example of the present disclosure.

FIG. 11 is a flow diagram illustrating a method of polarization-sensitive pre-processing for an eye/face tracking system in a near-eye device to mitigate stray light, according to examples of the present disclosure.

FIG. 12 is a flow diagram illustrating a method of stray light reduction for an eye/face tracking system in a near-eye device, according to examples of the present disclosure.

FIG. 13 is a schematic block diagram illustrating a configuration for polarization-sensitive stray light reduction for an eye/face tracking system in a near-eye device, according to various examples of the present disclosure.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

As used herein, a “wearable device” may refer to any portable electronic device that may be worn on any body part of a user and used to present audio and/or video content, control other devices, monitor bodily functions, and/or perform similar actions. As used herein, a “near-eye device” may refer to a device that may be in close proximity to a user's eye and may have optical capabilities, whereas a “near-eye display device” may refer to a device that may be in close proximity to a user's eye and may be capable of some sort of display to one or both of the user's eyes. Accordingly, a near-eye display device may be a head-mounted display (HMD) device, such as a wearable eyewear, a wearable headset, and/or “smartglasses,” which may be used for interacting with virtual reality (VR), augmented reality (AR), and/or any environment of real and/or virtual elements, such as a “metaverse.” As used herein, a “near-eye AR/VR display device” may refer to a near-eye display device which may be used to display and/or for interact with any virtual reality (VR) and/or augmented reality (AR) content, including, but not limited to, any virtual reality (VR) and/or augmented reality (AR) environment (such as a metaverse). As used herein, “AR/VR” may refer to one or more of augmented reality (AR), virtual reality(VR), and/or mixed reality (MR) depending on the particular context, as would be understood by one of ordinary skill in the art. As used herein, a “user” may refer to a user or wearer of a “wearable device,” “near-eye device,” “near-eye display device,” and/or “near-eye AR/VR display device,” depending on the context, which would be clear to one of ordinary skill in the art.

Stray light in near-eye devices with eye/face tracking capabilities poses significant challenges, especially when the eye/face tracking camera is positioned behind the lens. This unwanted light introduces glare, unwanted reflections, and other optical artifacts, leading to a degradation in the image quality captured by the eye/face tracking camera. As a result, essential details of the eye may be obscured, making it difficult for the system to accurately determine the user's gaze direction. Furthermore, the presence of stray light may complicate the detection of the pupil and glints, a primary method used in eye/face tracking. Artifacts or reflections caused by stray light may be mistaken for the pupil or diminish the visibility of the actual pupil, resulting in inaccurate or inconsistent tracking outcomes. Additionally, lens flare and internal reflections, which arise from multiple reflections within the lens elements or between the lens and other components, may produce bright spots or patterns in the captured image, further degrading the eye/face tracking process.

In some examples of the present disclosure, approaches are described for mitigating stray light in augmented and/or virtual reality (AR/VR) devices through infrared (IR) filters, neutral density filters, and a polarization-sensitive behind-the-lens camera in conjunction with polarized light sources. The near-eye devices according to examples of the present disclosure may include near-eye AR/VR display devices with, for example, behind-the-lens eye/face tracking systems, in-frame eye/face tracking systems, glass-embedded eye/face tracking cameras, waveguide-coupled eye/face tracking cameras, etc., as described in greater detail below. In some examples of the present disclosure, polarization-controlled illumination may be combined with polarization filtering in behind-the-lens eye/face tracking systems to minimize an amount of stray light that can reach the eye/face tracking camera. In other examples, polarization states may be measured with a polarization-sensitive camera and then suppressed at the image processing stage.

While some advantages and benefits of the present disclosure are apparent, other advantages and benefits may include enhanced accuracy and efficiency of eye/face tracking in a near-eye device (such as, e.g., a near-eye AR/VR display device) without increasing manufacturing or computational complexity.

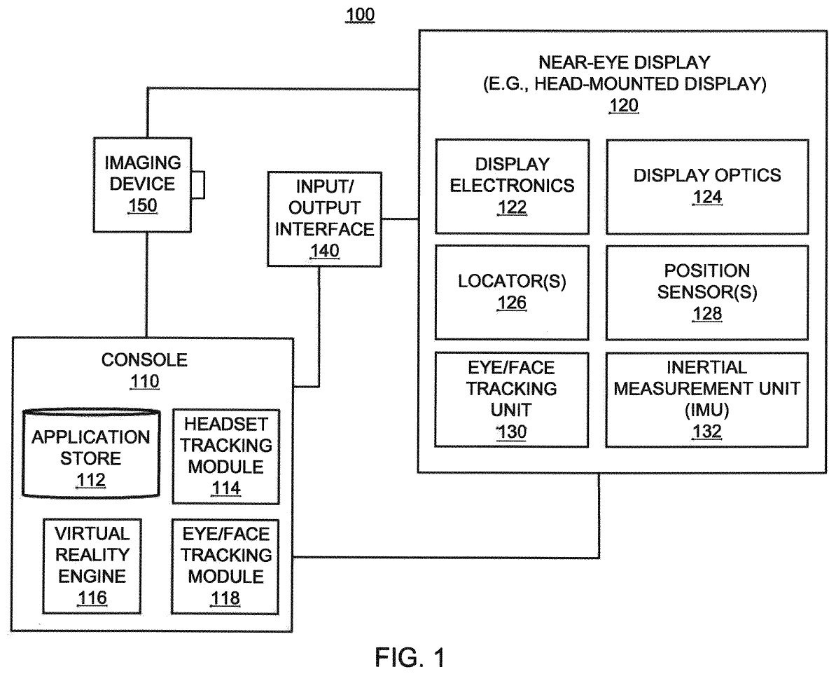

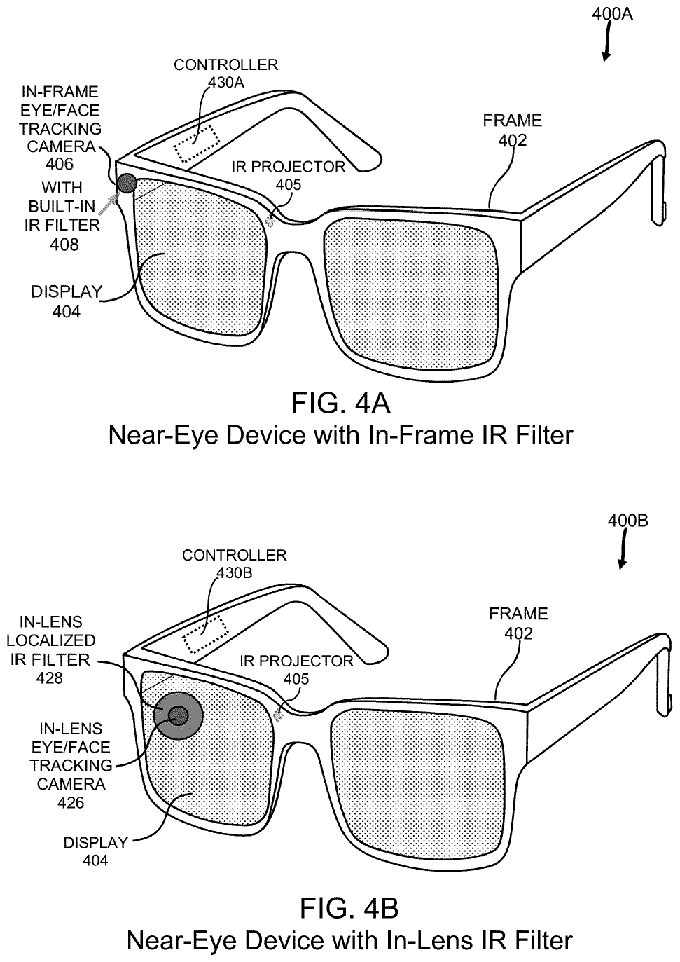

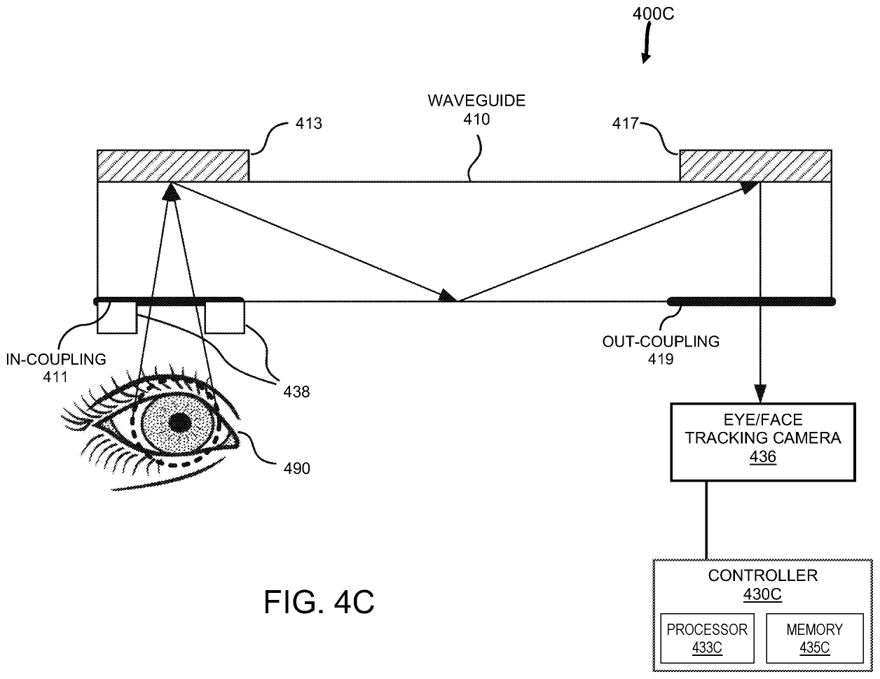

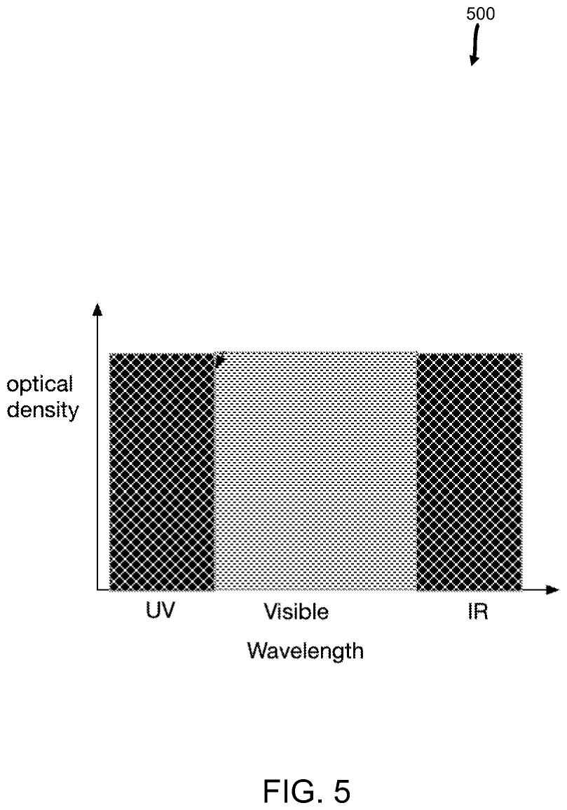

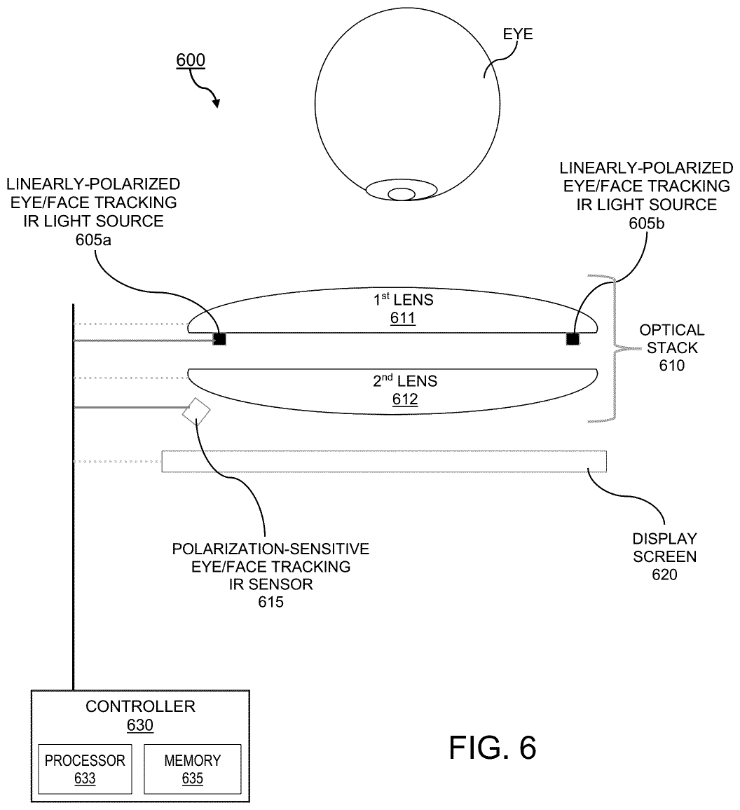

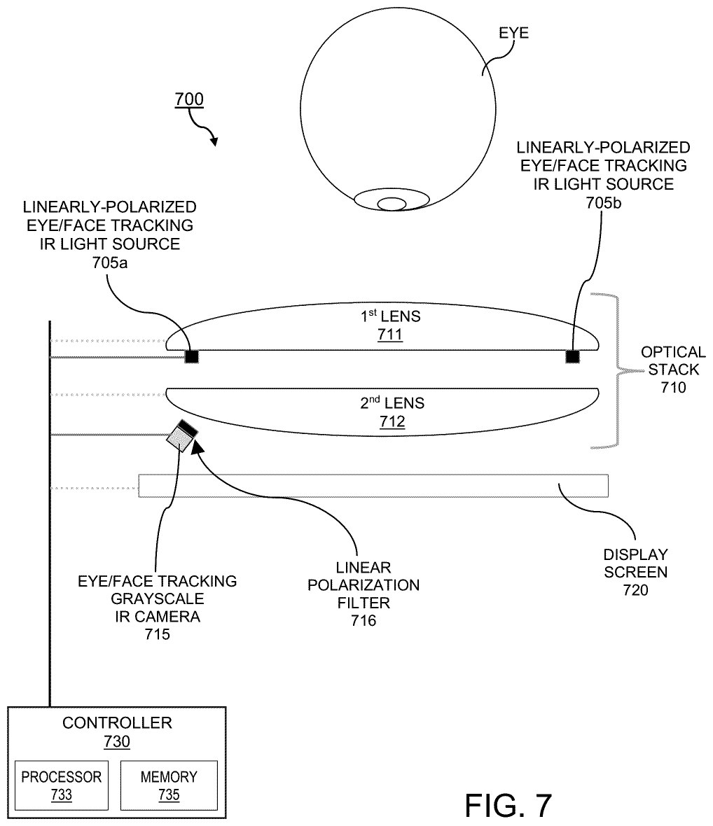

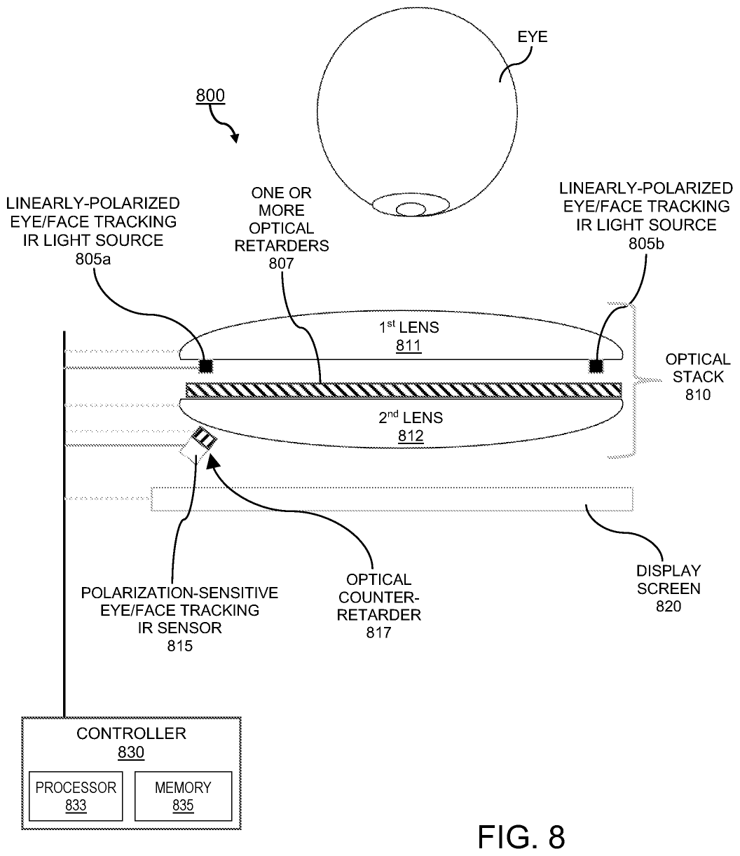

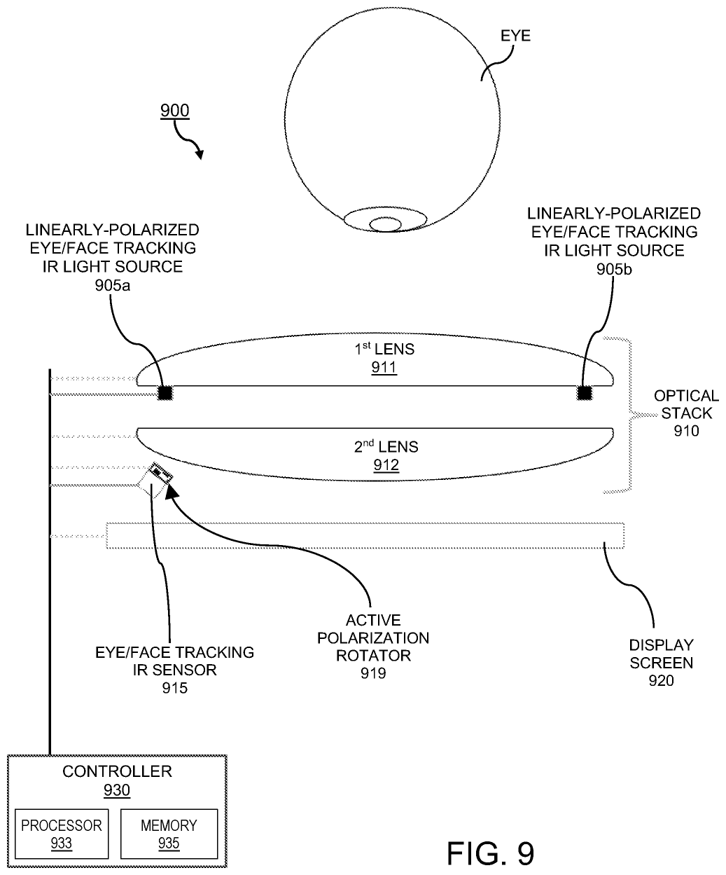

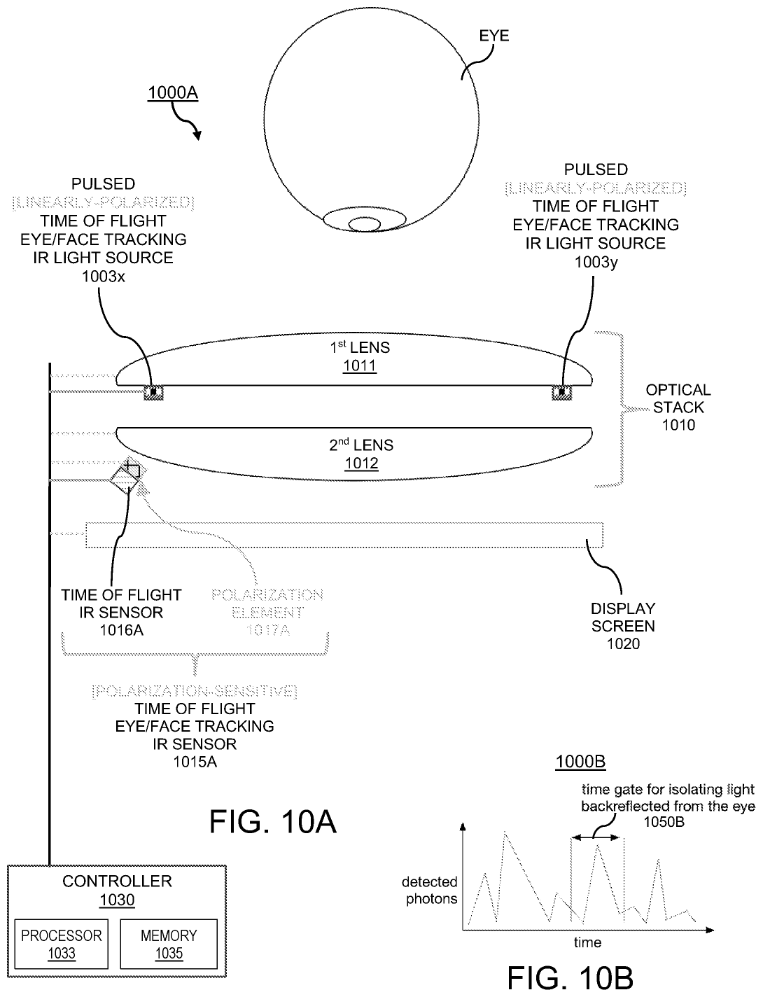

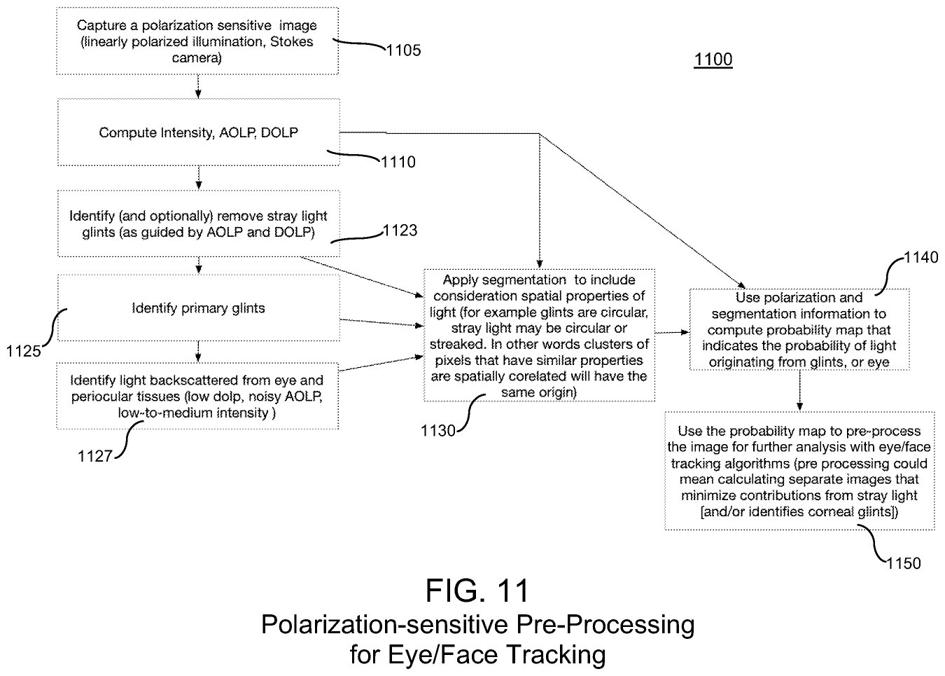

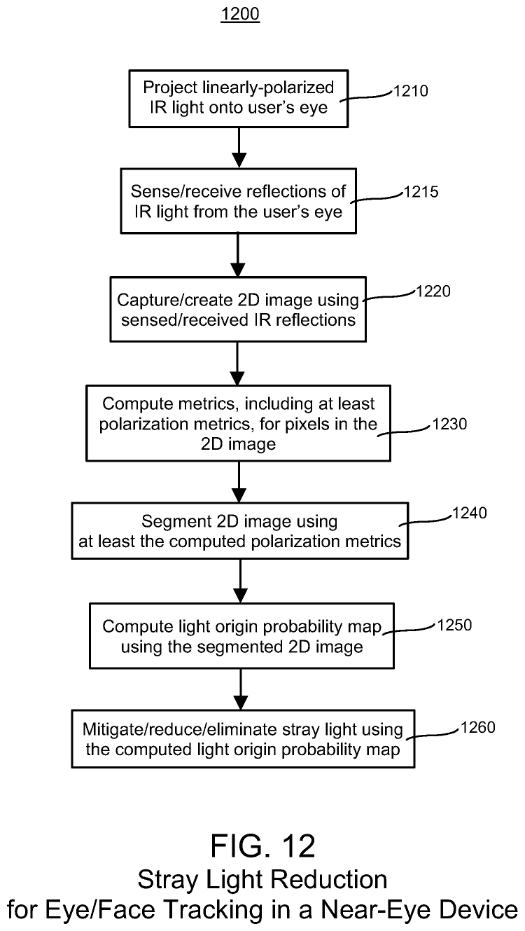

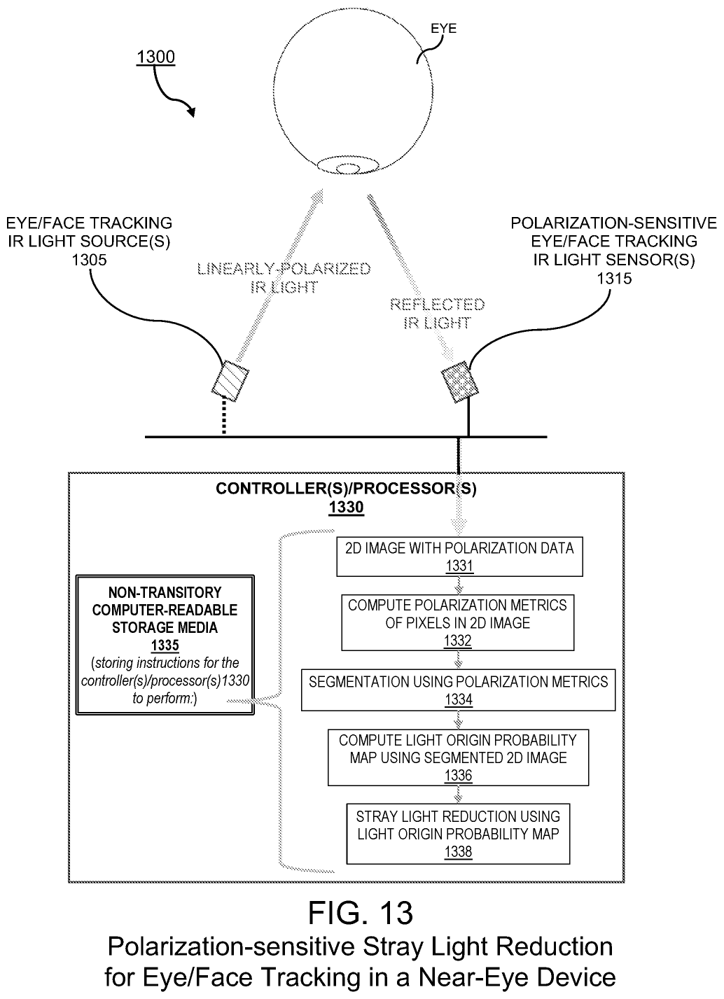

The following disclosure is broken down into 2 main sections and several sub-sections as follows:
I. NEAR-EYE DEVICE SYSTEM(s), describing near-eye devices which may be employed with examples of the present disclosure, with reference to FIGS. 1-3; and
II. STRAY LIGHT REDUCTION IN A NEAR-EYE DEVICE, discussing some of the problems caused by stray light in near-eye devices, as well as non-limiting examples of solutions to mitigate the effects of stray light in eye/face tracking systems in near-eye devices, in accordance with the present disclosure, including sub-sections:
   A. Placement of IR Filter(s) for Stray Light Reduction in a Near-Eye Device, discussing the usage of IR filters for stray light reduction according to examples of the present disclosure, with reference to FIGS. 4A-4C and 5, where FIG. 4A illustrates an in-frame IR filter configuration (with in-frame eye/face tracking camera), FIG. 4B illustrates a localized in-lens IR filter configuration (with an in-lens eye/face tracking camera), FIG. 4C illustrates a waveguide IR filter configuration (where the eye/face tracking camera is coupled to the waveguide), and FIG. 5 is a graphic showing optical density vs. visible wavelength which illustrates a structure of an IR cut-filter for in-frame and/or on-glass stray light mitigation, according to various examples of the present disclosure;
   B. Eye/Face Tracking Configurations for Stray Light Reduction in a Near-Eye Device, discussing configurations of IR light sources and IR light sensors which may be effective for stray light reduction in eye/face tracking systems, with reference to FIGS. 6-10B, where FIG. 6 shows a general configuration of a linearly-polarized eye/face tracking IR light source and a polarization-sensitive eye/face tracking IR sensor, FIG. 7 shows an eye/face tracking grayscale camera fitted with a linear polarization filter, FIG. 8 shows an optical stack which may contain one or more optical retarders, FIG. 9 shows an eye/face tracking IR sensor fitted with an active polarization rotator, FIG. 10A shows a Time of Flight (ToF) eye/face tracking system, and FIG. 10B is a graphic illustrating how FIG. 10A works, according to various examples of the present disclosure; and
   C. Methods for Stray Light Reduction in a Near-Eye Device, discussing methods of stray light reduction in eye/face tracking systems in near-eye devices, with reference to FIGS. 11-13, where FIG. 11 shows a method of polarization-sensitive pre-processing for an eye/face tracking system, FIG. 12 shows a method of stray light reduction for an eye/face tracking system in a near-eye device, and FIG. 13 is a schematic block diagram showing generally a configuration for polarization-sensitive stray light reduction for an eye/face tracking system in a near-eye device, according to various examples of the present disclosure.

### I. Near-Eye Device System(s)

FIG. 1 illustrates a block diagram of an artificial reality system environment 100 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As mentioned above, as used herein, a “user” may refer to a user or wearer of a “near-eye display.”

While this section describes near-eye devices (and, in particular, near-eye display devices), examples of the present disclosure are not limited thereto. For instance, examples of the present disclosure may apply to near-eye devices without specific image displaying capabilities, such as, for example, the Ray-Ban™|Meta™ line of smartglasses. Moreover, examples of the present disclosure are expressly intended to apply to other wearable devices (as defined above) besides the near-eye devices described herein, including other wearable computing platforms, which may have, e.g., Internet of Things (IoT), audio/visual, health monitoring, WiFi and radio reception, and/or other capabilities, such as smartwatches, compute “pucks,” as would be understood by one of ordinary skill in the art.

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user. As would be understood by one of ordinary skill in the art, FIG. 1 is a schematic diagram, and is not indicative of size, location, orientation, and/or relative sizes/locations/orientations of any of the systems, components, and/or connections shown therein. In addition, some components which would be understood as possible in various implementations, such as a “bus” connecting some, or all, of the components shown inside the near-eye display device 120 in FIG. 1; however, all of the components therein may be connected by the same bus and/or busses, or may have direct and/or indirect connections with, e.g., various processor(s). Such electrical, control, and/or power connections may be implemented in a large variety of ways, as would be understood by one of ordinary skill in the art.

In some instances, for a near-eye display system, it may generally be desirable to expand an eye box, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular head-mounted display (HMD)) or both eyes (for binocular head-mounted displays (HMDs)). Also, as used herein, an “eye box” may be a two-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eye box.

In some examples, the near-eye display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

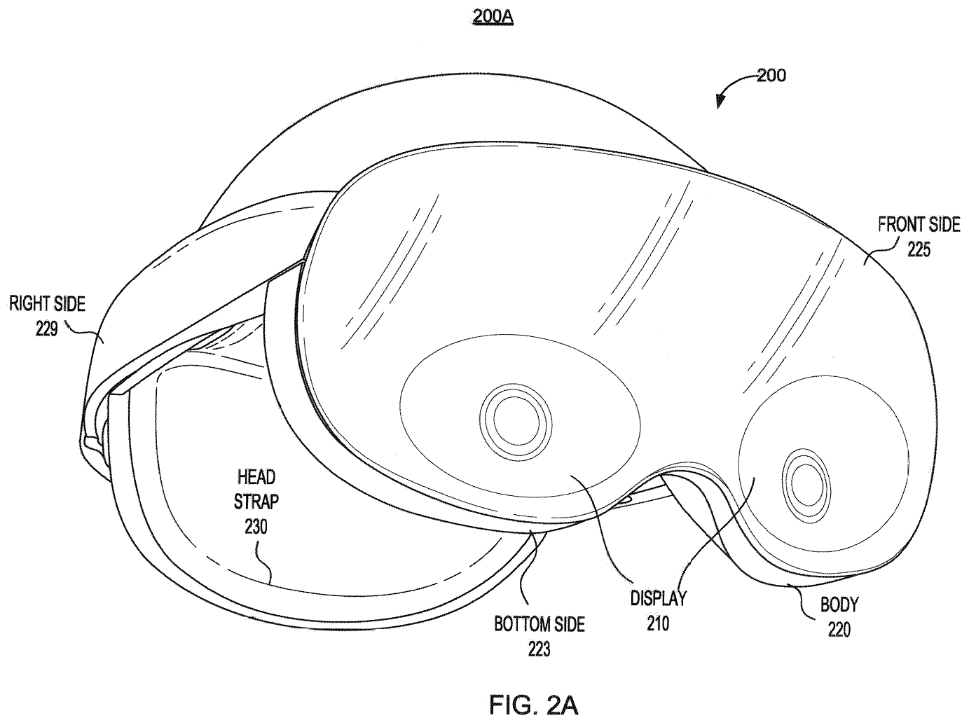

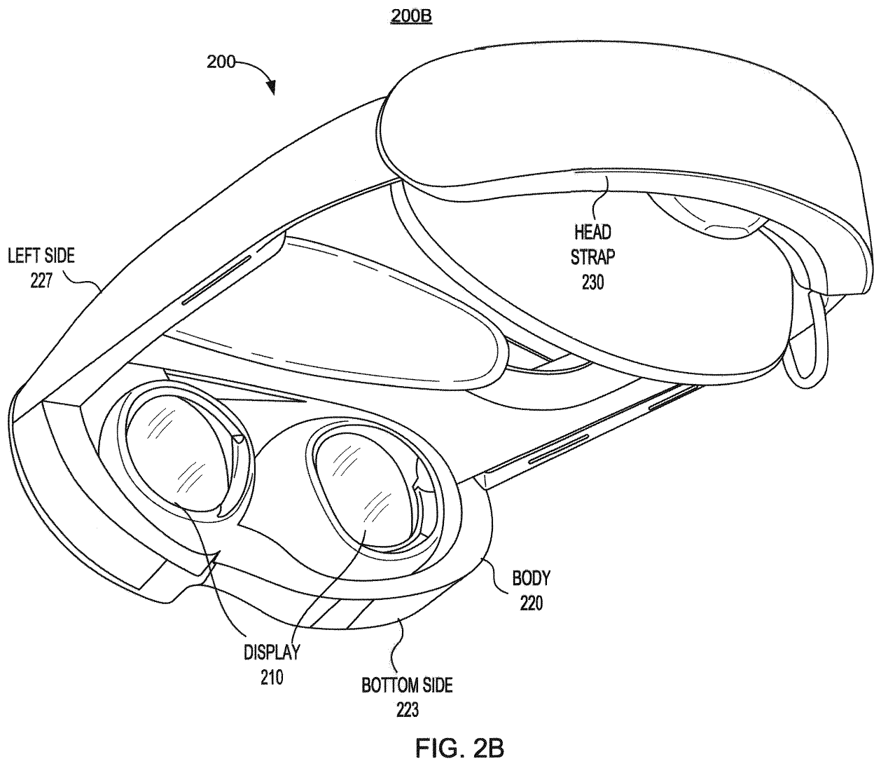

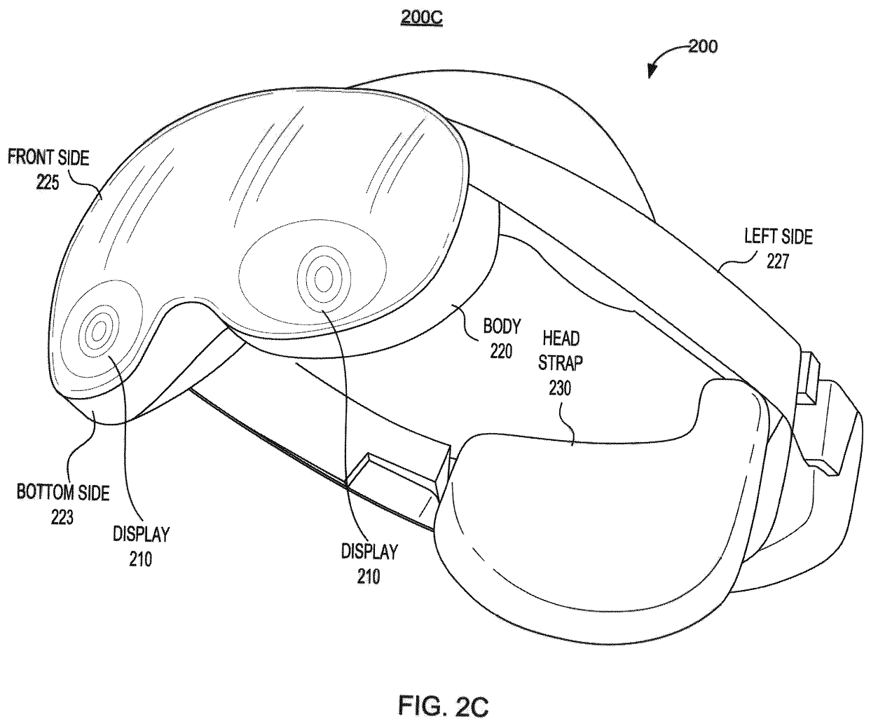

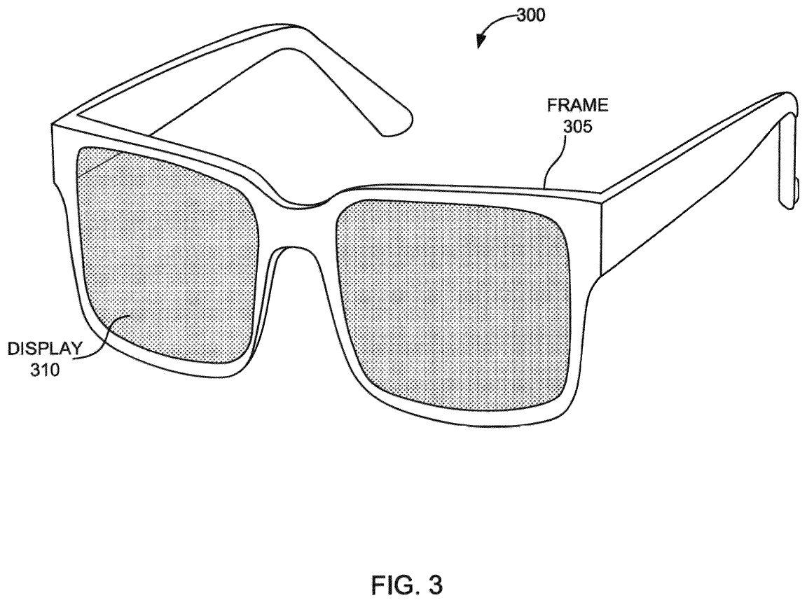

In some examples, the near-eye display 120 may be implemented in any suitable form-factor, including a head-mounted display (HMD), a pair of glasses, or other similar wearable eyewear or device. Examples of the near-eye display 120 are further described below with respect to FIGS. 2 and 3. Additionally, in some examples, the functionality described herein may be used in a head-mounted display (HMD) or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye/face tracking unit 130. In some examples, the near-eye display 120 may also include one or more locators 126, one or more position sensors 128, and an inertial measurement unit (IMU) 132. In some examples, the near-eye display 120 may omit any of the eye/face tracking unit 130, the one or more locators 126, the one or more position sensors 128, and the inertial measurement unit (IMU) 132, or may include additional elements. In some examples, the near-eye display device 120 may include additional components, such as a wireless communication sub-system, one or more outward projectors, and/or one or more inward projectors. As would be understood by one of ordinary skill in the art, various operational, electronic, communication (for, e.g., control signals), electrical and other such connections may or may not also be included between and among the components of the near-eye display device 120.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the near-eye display 120 may include a projector (not shown), which may form an image in the angular domain for direct observation by a viewer's eye through a pupil. The projector may employ a controllable light source (e.g., a laser source) and a micro-electromechanical system (MEMS) beam scanner to create a light field from, for example, a collimated light beam. In some examples, the same projector or a different projector may be used to project a fringe pattern on the eye, which may be captured by a camera and analyzed (e.g., by the eye/face tracking unit 130) to determine a position of the eye (the pupil), a gaze, etc. In some examples, the display electronics 122 may include and/or be operationally connected to the one or more outward projectors and/or the one or more inward projectors; in some examples, the eye/face tracking unit 130 may also include and/or be operationally connected to one or more inward projectors. In some examples, there may be operational and/or other connections between and among the display electronics 122, the eye/face tracking unit 130, one or more outward projectors, one or more inward projectors, and/or other components, as would be understood by one of ordinary skill in the art.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the display optics 124 may include one or more of a beam-forming element, a beam-shaping element, an aperture, a Fresnel lens, a refractive element (such as, e.g., a lens), a reflective element (such as, e.g. a mirror), a diffractive element, a polarization element, a waveguide, a filter, or any other optical element suitable for affecting and/or otherwise manipulating light emitted from one or more inward projectors (and/or otherwise created by the display electronics 122). In some examples, the display optics 124 may include an optical coating, such as an anti-reflective coating, a reflective coating, a filtering coating, and/or a combination of different optical coatings. In some examples, the display optics 124 may include a Pancharatnam-Berry phase (PBP) or other phase-modification elements, a surface grating, a high-contrast grating, diffractive gratings (such as, e.g. Polarization Volumetric Hologram-based (PVH) gratings, Surface Relief Gratings (SRGs), Volume Bragg Gratings (VBGs), a diffractive optical element (DOE), etc.), nano-optics (including, e.g., metalenses and metasurfaces), micro-structures (including those fabricated using 3D printing), a liquid lens, a mask (such as, e.g., a phase mask), surface coatings, lithographically-created layered waveguides, and/or any other suitable technology, layer, coating, and/or material feasible and/or possible either presently or in the future, as would be understood by one of ordinary skill in the art.

For additional details concerning the architecture and constructions of metasurfaces, metalenses, and nonlocal flat optics which may be employed in the optics, projectors, sensors, and other components of examples of the present disclosure, see, for example, Zheng et al., Compound Meta-Optics for Complete and Loss-Less Field Control, ACS Nano 2022, 16, 15100-15107; https://doi.org/10.1021/acsnano.2c06248; which discusses multilayer optical metasurfaces in the design space of flat optics which offer compact platforms for the manipulation of the amplitude, phase, and/or polarization state of light; Shastri & Monticone, Nonlocal Flat Optics, Nature Photonics, vol. 17, pp. 36-47 (22 Dec. 2022); https://doi.org/10.1038/s41566-022-01098-5; and Chen, A. & Monticone, F., Dielectric Nonlocal Metasurfaces for Fully Solid-State Ultrathin Optical Systems, ACS Photonics, vol. 8, issue 5, pp. 1439-1447 (2021), both of which are hereby incorporated by reference in their entireties.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube reflector, a reflective marker, a type of light source that contrasts with an environment in which the near-eye display 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display 120 that may be relative to an initial position of the near-eye display 120. For example, the inertial measurement unit (IMU) 132 may integrate measurement signals received from accelerometers over time to estimate a velocity vector and integrate the velocity vector over time to determine an estimated position of a reference point on the near-eye display 120. Alternatively, the inertial measurement unit (IMU) 132 may provide the sampled measurement signals to the optional console 110, which may determine the fast calibration data.

In some examples, the near-eye display 120 may include a wireless communication subsystem, such as, e.g., an ultra-wide band (UWB) transceiver. Ultra-wide band (UWB) wireless communication technology is used for short-range, fast, and secure data transmission environments. Ultra-wide band (UWB) wireless communication technology provides high transmission speed, low power consumption, and large bandwidth, in addition to the ability to co-exist with other wireless transmission technologies. The ultra-wide band (UWB) transceiver may be used to detect another user (head-mounted display (HMD) device) within range of communication and within an angle-of-arrival (AoA), then establish line-of-sight (LoS) communication between the two users. The communication may be in audio mode or in audio/video mode. In other examples, the ultra-wide band (UWB) transceiver may be used to detect the other user, but a different communication technology (transceiver) such as WiFi or Bluetooth Low Energy (BLE) may be used to facilitate the line-of-sight (LoS) communication. In some examples, a wireless communication subsystem may include one or more global navigation satellite system (GNSS) receivers, such as, e.g., a global positioning service (GPS) receiver, one or more transceivers compliant with the Institute of Electrical & Electronic Engineers (IEEE) 803.11 family of present and/or future standards (such as, e.g., “WiFi”), one or more Bluetooth transceivers, one or more cellular receivers and/or transmitters (compliant with any of the 3^{rd} Generation Partnership Project (3GPP), Open Radio Access Network (O-RAN), evolved Common Public Radio Interface (eCPRI), etc., standards), and/or any other receiver and/or transmitter compliant with any suitable communication protocol (also including any unnamed protocols, such as WiMax, NearLink, Zigbee, etc., that would be known to one of ordinary skill in the art). In some instances, any of these communication transceivers may also be implemented in other suitable components of the near-eye display device 120, I/O interface 140, and/or console 110. In some cases, multiple wireless communication transceivers may be available for, inter alia, any wireless communication subsystem and/or other components of the system 100, and the one with lowest power consumption, highest communication quality (e.g., based on interfering signals), or user choice may be used. For example, the communication technology may be selected based on a lowest power consumption for a given range.

The eye/face tracking unit 130 may include one or more eye/face tracking systems. As used herein, “eye/face tracking” may refer to determining an eye's position or relative position, including orientation, location, and/or gaze of a user's eye, and/or determining eye-adjacent facial characteristics and/or parameters, such as measurements of the flesh covering the orbital socket, the eyelids, the eyebrows, and/or any other regions around an eye (or optionally elsewhere on the face of the user). In some examples, an eye/face tracking system may include an imaging system that captures one or more images of an eye and may optionally include a light emitter, which may generate light (e.g., a fringe pattern) that is directed to an eye such that light reflected by the eye may be captured by a sensor (e.g., a camera). and analyzed (e.g., by the eye/face tracking unit 130 and/or the eye/face tracking module 118 in the optional console 110) to determine a position of the eye (the pupil), a gaze, etc., and/or characteristics of one or more portions of the face (including the region immediately adjacent to the eye). In other examples, the eye/face tracking unit 130 may capture reflected radio waves emitted by a miniature radar unit. These data associated with the eye and/or face may be used to determine or predict eye position, orientation, movement, location, gaze, etc., and/or characteristics of one or more portions of the face (including the region immediately adjacent to the eye). Although portions of the present disclosure may refer to “eye tracking” or to the “tracking,” “imaging,” sensing,” etc., of an eye and/or portions of tan eye, without explicitly mentioning facial tissue, examples of the present disclosure may also be applied to facial tissue, as would be understood by one of ordinary skill in the art.

In some examples, the near-eye display device 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye/face tracking unit 130 may be able to determine where the user is looking or predict any user patterns, etc. In some examples, one or more outward-facing sensor(s) may be included such as, e.g., a camera, an image sensor, such as a complementary metal-oxide semiconductor (CMOS) image sensor, a defocused image sensor, a light field sensor, a single photon avalanche diode (SPAD), and/or, in certain implementations, a non-imaging sensor, such as a self-mixing interferometer (SMI) sensor. In some examples, the one or more outward-facing sensor(s) may be a combined VCSEL/SMI integrated circuit which may be employed as both a light source and a sensor. In some examples, the one or more outward-facing sensor(s) may be employed for purposes of creating a user-responsive AR/VR display environment by sensing the external environment in relation to the user.

In some examples, any projectors operably connected to the display electronics 122 and/or the eye/face tracking unit 130, and/or any other one or more outward and/or inward projectors may employ a controllable light source (e.g., a laser) and a micro-electromechanical system (MEMS) beam scanner to create a light field from, for example, a collimated light beam. In some examples, the light source of any one or more projectors may include one or more of a Vertical Cavity Surface Emitting Laser (VCSEL), liquid crystal display (LCD), a light emitting diode (LED) or micro-light emitting diode (mLED), an organic light emitting diode (OLED), an inorganic light emitting diode (ILED), an active-matrix organic light emitting diode (AMOLED), a transparent organic light emitting diode (TLED), any other suitable light source, and/or any combination thereof, as would be understood by one of ordinary skill in the art. In some examples, the one or more projectors may include a single electronic display or multiple electronic displays (e.g., one for each eye of the user), as would be understood by one of ordinary skill in the art.

In some examples, any control electronics, such as, the display electronics 122, the eye/face tracking unit 130, the display optics 124 (in implementations having active components), and/or any of the other components of the near-eye display device 120 may be implemented in and/or by any number of processors executing instructions stored on any number of non-transitory computer-readable storage media (not shown) disposed on/in and/or communicatively linked to the near-eye display device 120. The one or more processors 121 may include multiple processing units executing instructions in parallel. The non-transitory computer-readable storage medium/media may be any memory, such as a hard disk drive, a removable memory, or a solid-state drive (e.g., flash memory or dynamic random access memory (DRAM)). In some examples, one or more processors in the near-eye display device 120 may perform one or more functions; in some examples, one or more non-transitory computer-readable storage media in the near-eye display device 120 may store instructions that, when executed by one or more processors, cause the one or more processors to perform any of the functions described herein and/or to control any of the components described herein. In some examples, functions such as those described below in reference to the optional console 110 (e.g., eye/face tracking, headset tracking, and the generation of virtual reality images) may be performed by the one or more processors integrated with and/or wired/wirelessly connected to the near-eye display device 120.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from one or more of external imaging device 150, the near-eye display 120, and the input/output interface 140. For example, in the example shown in FIG. 1, the optional console 110 may include an application store 112, a headset tracking module 114, a virtual reality engine 116, and an eye/face tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. As used herein, “media” should be understood as the term is used in typical English parlance, i.e., as including both the singular (“medium”) and the plural (“media”). It should be appreciated that the optional console 110 may or may not be needed or the optional console 110 may be integrated with or separate from the near-eye display 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display 120 using slow calibration information from the external imaging device 150. For example, the headset tracking module 114 may determine positions of a reference point of the near-eye display 120 using observed locators from the slow calibration information and a model of the near-eye display 120. Additionally, in some examples, the headset tracking module 114 may use portions of the fast calibration information, the slow calibration information, or any combination thereof, to predict a future location of the near-eye display 120. In some examples, the headset tracking module 114 may provide the estimated or predicted future position of the near-eye display 120 to the virtual reality engine 116.

In some examples, the virtual reality engine 116 may execute applications within the artificial reality system environment 100 and receive position information of the near-eye display 120, acceleration information of the near-eye display 120, velocity information of the near-eye display 120, predicted future positions of the near-eye display 120, or any combination thereof from the headset tracking module 114. In some examples, the virtual reality engine 116 may also receive estimated eye position and orientation information from the eye/face tracking module 118. Based on the received information, the virtual reality engine 116 may determine content to provide to the near-eye display 120 for presentation to the user.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

Generally speaking, any one or more components shown in FIG. 1 may be further broken down into sub-components and/or combined together to form larger modules, as would be understood by one of ordinary skill in the art. For example, in some examples, the near-eye display device 120 may include additional, fewer, and/or different components than shown and/or described in reference to FIG. 1. Moreover, groupings of components may work together as sub-systems within the near-eye display device 120, and/or share/provide/transmit data and/or control information, etc., as would be understood by one of ordinary skill in the art. For example, as indicated by the dotted line box connecting/overlapping the display electronics 122, any outward-facing and/or inward-facing sensor(s), any one or more outward and/or inward projectors, and the eye/face tracking unit 130 in FIG. 1, these listed components may work together and/or may be somewhat integrated in terms of form and/or function in actual implementations of the near-eye display device 120 in FIG. 1, as would be understood by one of ordinary skill in the art.

FIGS. 2A, 2B, and 2C illustrate a front prospective view, a back prospective view, and a front prospective view (as seen from below), respectively, of a near-eye display device in the form of a head-mounted display (HMD) device 200, to which examples of the present disclosure may be applied. In some examples, the head-mounted display (HMD) device 200 may be a specific implementation of the near-eye display 120 of FIG. 1, and may be configured to operate as a virtual reality (VR) system, an augmented reality (AR) system, and/or as part of any such digital content display system that uses displays or wearables, or any combination thereof. In some examples, the head-mounted display (HMD) device 200 may include a display 210, a body 220 and a head strap 230. In some examples, the head-mounted display (HMD) device 200 may include additional, fewer, and/or different components than shown and/or described in reference to FIGS. 2A-2B.

FIG. 2A is a frontal prospective view 200A of the head-mounted display (HMD) device 200 showing a body 220 and a head strap 230, as well as a bottom side 223, a front side 225, and a right side 229 of the body 220. FIG. 2B is a bottom rear prospective view 200B of the head-mounted display (HMD) device 200 showing the body 220, the head strap 230, the bottom side 223 and a left side 227 of the body 220. FIG. 2C is a bottom frontal prospective view 2000 of the head-mounted display (HMD) device 200 showing the front side 225 (in which the display 210 may be disposed), the body 220, the head strap 230, and the bottom side 223 and the left side 227 of the body 220.

In some examples, the head strap 230 may have an adjustable or extendible length. In particular, in some examples, there may be a sufficient space between the body 220 and the head strap 230 of the head-mounted display (HMD) device 200 for allowing a user to mount the head-mounted display (HMD) device 200 onto the user's head. For example, the length of the head strap 230 may be adjustable to accommodate a range of user head sizes. In some examples, the head-mounted display (HMD) device 200 may include additional, fewer, and/or different components such as a display 210 to present a wearer AR/VR content and a camera to capture images or videos of the wearer's environment. In some examples, two or more outward-facing cameras may be employed for, e.g., a stereoscopic viewing by the user by display projectors inside the head-mounted display (HMD) device 200.

In some examples, the display 210 may include one or more display assemblies and present, to a user (wearer), media or other digital content including virtual and/or augmented views of a physical, real-world environment with computer-generated elements. Examples of the media or digital content presented by the head-mounted display (HMD) device 200 may include images (e.g., two-dimensional (2D) or three-dimensional (3D) images), videos (e.g., 2D or 3D videos), audio, or any combination thereof. In some examples, the user may interact with the presented images or videos through eye/face tracking sensors enclosed in the body 220 of the head-mounted display (HMD) device 200. The eye/face tracking sensors may also be used to adjust and improve quality of the presented content.

In some examples, the display 210 and/or related optics (and/or any of the systems discussed herein) may utilize optics suitable for any of AR, VR, and/or MR display, such as, for example, folded optics and/or pancake optics, as would be understood by one of ordinary skill in the art. See, e.g., U.S. Pat. No. 11,372,239 entitled “Enabling Eye Tracking in Pancake Lens Optics” and assigned to the present assignee/applicant and/or an affiliate thereto (hereinafter, “Meta's ′239 patent”), U.S. Pat. No. 11,054,622 entitled “Folded Viewing Optics with an Optical Retarder on a Simple Surface” and assigned to the present assignee/applicant and/or an affiliate thereto (hereinafter, “Meta's 622 patent”), and/or U.S. Pat. No. 11,022,784 entitled “Use of Folded Optics to Reduce Volume in a Virtual-Reality System” and assigned to the present assignee/applicant and/or an affiliate thereto (hereinafter, “Meta's 784 patent”), all of which are hereby incorporated by reference in their entireties.

In some examples, the head-mounted display (HMD) device 200 may include various sensors (not shown), such as depth sensors, motion sensors, position sensors, and/or eye/face tracking sensors. Some of these sensors may use any number of structured or unstructured light patterns for sensing purposes. In some examples, the head-mounted display (HMD) device 200 may include an input/output interface for communicating with a console communicatively coupled to the head-mounted display (HMD) device 200 through wired or wireless means. In some examples, the head-mounted display (HMD) device 200 may include a virtual reality engine (not shown) that may execute applications within the head-mounted display (HMD) device 200 and receive depth information, position information, acceleration information, velocity information, predicted future positions, or any combination thereof of the head-mounted display (HMD) device 200 from the various sensors.

In some examples, the information received by the virtual reality engine may be used for producing a signal (e.g., display instructions) to the display 210. In some examples, the head-mounted display (HMD) device 200 may include locators (not shown), which may be located in fixed positions on the body 220 of the head-mounted display (HMD) device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped like eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

In some examples, any display electronics and display optics of the head-mounted display (HMD) device 200 may display and/or facilitate the display of media or other digital content including virtual and/or augmented views of a physical, real-world environment with computer-generated elements. Examples of the media or digital content presented by the head-mounted display (HMD) device 200 may include images (e.g., two-dimensional (2D) or three-dimensional (3D) images), videos (e.g., 2D or 3D videos), audio, or any combination thereof. In some examples, the display electronics may display a three-dimensional (3D) image, e.g., using stereoscopic effects produced by two-dimensional panels, to create a subjective perception of image depth. In some examples, the display optics in the head-mounted display (HMD) device 200 may include a single optical element or any number of combinations of various optical elements, such as waveguides, gratings, optical lenses, optical couplers, mirrors, etc., as well as mechanical couplings to maintain relative spacing and orientation of the optical elements in the combination, such as are described above in reference to the display optics 124 in FIG. 1.

In some examples, the head-mounted display (HMD) device 200 in FIGS. 2A-2B may include one or more inward/outward projectors, similar to the inward and/or outward projectors discussed in reference to FIG. 1. In some examples, one or more inward projectors of the head-mounted display (HMD) device 200 may project an image for direct observation by the user's eye and/or project a fringe or other pattern on the eye. In some examples, one or more outward projectors of the head-mounted display (HMD) device 200 may project a fringe or other pattern on the external environment and/or objects/surfaces within the external environment in order to, for example, perform 3-dimensional (3D) mapping of the external environment. In some examples, the one or more inward/outward projectors of the head-mounted display (HMD) device 200 may include one or more of Vertical Cavity Surface Emitting Laser (VCSEL), a liquid crystal display (LCD) and/or a light-emitting diode (LED); more specifically, the one or more inward/outward projectors of the head-mounted display (HMD) device 200 may include, e.g., one or more of a liquid crystal display (LCD), a light emitting diode (LED) or micro-light emitting diode (mLED), an organic light emitting diode (OLED), an inorganic light emitting diode (ILED), an active-matrix organic light emitting diode (AMOLED), a transparent organic light emitting diode (TLED), any other suitable light source, and/or any combination thereof. It should be appreciated that in some examples, the inward projectors of the head-mounted display (HMD) device 200 may be placed near and/or closer to a user's eye (e.g., “eye-side”). It should be appreciated that, in some instances, utilizing a back-mounted inward projector may help to reduce size or bulkiness of any housing for a display system, which may also result in a significant improvement in user experience for a user.

In some examples, the head-mounted display (HMD) device 200 may also include an eye/face tracking system, one or more locators, one or more position sensors, and an inertial measurement unit (IMU), similar to the eye/face tracking unit 130, the one or more locators 126, the one or more position sensors 128, and the inertial measurement unit (IMU) 132, respectively, described in reference to FIG. 1. In some examples, the head-mounted display (HMD) device 100 may include various other sensors, such as depth sensors, motion sensors, image sensors, light sensors, and/or the like. Some of these sensors may sense any number of structured or unstructured light patterns projected by the one or more inward/outward projectors of the head-mounted display (HMD) device 200 for any number of purposes, including, e.g., sensing, eye/face tracking, and/or the creation of virtual reality (VR) content.

In some examples, the head-mounted display (HMD) device 200 may include and/or be operably connected to a virtual reality engine (not shown), similar to the virtual reality engine 116 described in reference to FIG. 1, that may execute applications within the head-mounted display (HMD) device 200 and receive depth information, position information, acceleration information, velocity information, predicted future positions, or any combination thereof of the head-mounted display (HMD) device 200 from the various sensors. In some examples, the information received by the virtual reality engine may be used for producing a signal (e.g., display instructions) to the one or more display assemblies. In some examples, the head-mounted display (HMD) device 200 may include locators (not shown), similar to the one or more locators 126 described in reference to FIG. 1, which may be located in fixed positions on the body 220 of the head-mounted display (HMD) device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

As stated above, the head-mounted display (HMD) device 200 may include additional, fewer, and/or different components than shown and/or described in reference to FIGS. 2A-2B. In some examples, the head-mounted display (HMD) device 200 may include an input/output interface (similar to the input/output interface 140 in FIG. 1), a console (similar to the console 110 described in reference to FIG. 1), and/or a camera to capture images or videos of the user's environment to present the user with, e.g., augmented reality (AR)/virtual reality (VR) content. In some examples, the head-mounted display (HMD) device 200 may include one or more cameras to capture reflections of patterns projected by the one or more inward/outward projectors. As mentioned above, in some examples, the head-mounted display (HMD) device 200 in FIGS. 2A-2B may include two or more outward-facing cameras, such as the three outward-facing cameras employed in the Quest 3™ and Quest 3S™ from Meta™.

In some examples, the head-mounted display (HMD) device 200 (including, e.g., the display 210) in FIGS. 2A-2B may include any number of processors, display electronics, and/or display optics similar to the display electronics 122 and the display optics 124 described in reference to FIG. 1. For example, in some examples, an outward-facing camera may be under the control of a processor, and/or be operationally connected to the display electronics 122 and/or the eye/face tracking unit 130 in FIG. 1. As mentioned above, in some examples, the head-mounted display (HMD) device 200 in FIGS. 2A-2B may include two or more outward-facing cameras rather than a single outward-facing camera, such as the three outward-facing cameras employed in the Quest 3™ and Quest 3S™ from Meta™.

FIG. 3 is a frontal perspective view of a near-eye display 300 in the form of a pair of glasses (or other similar eyewear), according to an example. In some examples, the near-eye display device 300 may be a specific implementation of the near-eye display device 120 of FIG. 1, and may be configured to operate as a virtual reality (VR) system, an augmented reality (AR) system, and/or as part of any such content system that uses displays or wearables, or any combination thereof. In some examples, the near-eye display device 300 may include an inward-facing and/or an outward-facing projection systems, such as are described and discussed below in reference to FIGS. 4A-4B et seq., to which examples of the present disclosure may be applied.

As shown in FIG. 3, the near-eye display 300 may include a frame 305 and a display 310. In some examples, the display 310 may be configured to present media or other content to a user. In some examples, the display 310 may include display electronics and/or display optics, similar to components described with respect to FIGS. 1 and 2A-2C. For example, as described above with respect to the near-eye display 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc. In other examples, the display 310 may include a projector, or in place of the display 310 the near-eye display 300 may include a projector.

In some examples, the near-eye display 300 may further include various sensors on or within a frame 305. In some examples, the various sensors may include any number of depth sensors, motion sensors, position sensors, inertial sensors, and/or ambient light sensors, as shown. In some examples, the various sensors may include any number of image sensors configured to generate image data representing different fields of views in one or more different directions. In some examples, the various sensors may be used as input devices to control or influence the displayed content of the near-eye display, and/or to provide an interactive virtual reality (VR), augmented reality (AR), and/or mixed reality (MR) experience to a user of the near-eye display 300. In some examples, the various sensors may also be used for stereoscopic imaging or other similar applications.

As would be understood by one of ordinary skill in the art, the near-eye display device 300 may include one or more outward projectors (such as, e.g., pattern projectors), one or more eye/face tracking projectors (which may effectively operate as inward pattern projectors), one or more inward projectors (for other than eye/face tracking and/or fringe pattern projection), one or more outward-facing camera(s), one or more eye/face tracking camera(s), etc. In some examples, the inward-facing imaging/projection system of the near-eye display device 300 may be an eye/face tracking system, where one or more eye/face tracking projectors project a pattern directly on the user's eye(s) and/or face, and one or more eye/face tracking camera(s) captures one or more reflections of the projected pattern from the user's eye(s) and/or face, and the eye/face tracking system uses the captured reflections to track the user's eye(s) and/or face.

In some examples, one or more eye/face tracking projectors may be disposed on the temple arms of the frame 305 of the near-eye display device 300 (not shown in FIG. 3), and may project one or more patterns on eye lens of the near-eye display device 300, which reflects those one or more patterns onto the user's eye and/or face (i.e., a rear projection light source). In such examples, the inner surface of the eye lens may be coated with a reflective surface, fabricated with a reflective surface, and/or covered by a metasurface or other type of nanostructure which may be suitably employed for the re-direction of the light projected by one or more eye/face tracking projectors, as would be understood by one of ordinary skill in the art. In such examples, the inner surface may create the one or more patterns which are projected onto the user's eye and/or face, either alone or in combination with one or more eye/face tracking projectors. In other words, in some examples, one or more eye/face tracking projectors may project unstructured light, and the inner surface both reflects and/or re-directs the light onto the user's eye and/or face while also providing one or more patterns which may be used for eye/face tracking. In some examples, the one or more eye/face tracking projectors may project a pattern such as, for example, a structured image (e.g., a fringe pattern) projected onto the eye and/or face by a micro-electromechanical system (MEMS) based scanner reflecting light from a light source (e.g., a laser).

In some examples, one or more eye/face tracking projectors in any of the examples described and/or discussed herein may include one or more of a light emitting diode (LED) or micro-light emitting diode (mLED) or edge emitting LED, an organic light emitting diode (OLED), an inorganic light emitting diode (ILED), an active-matrix organic light emitting diode (AMOLED), a transparent organic light emitting diode (TLED), a superluminescent diode (SLED), another type of suitable light emitting diode, a Vertical Cavity Surface Emitting Laser (VCSEL) or other type of laser, a photonic integrated circuit (PIC) based illuminator, a liquid crystal display (LCD), a light source with a micro-electromechanical system (MEMS) based scanner, any other suitable light source, and/or any combination thereof. In any examples employing a VCSEL, the VCSEL may have one or more of a wide variety of possible VCSEL architectures, and/or fabrications, as would be understood by one of ordinary skill in the art. In such examples, the VCSEL may include a VCSEL with multiple active regions (e.g., a bipolar cascade VCSEL); a tunnel junction VCSEL; a tunable VCSEL which may employ, e.g., a micro-electromechanical system (MEMS); a wafer-bonded and/or wafer-fused VCSEL; a Vertical External Cavity Surface Emitting Laser (VECSEL); a Vertical Cavity Semiconductor Optical Amplifier (VCSOA) which may be optimized as amplifiers as opposed to oscillators; two or more Vertical Cavity Surface Emitting Lasers (VCSELs) disposed on top of one another (i.e., vertically) such that each one pumps the one on top of it (e.g., monolithically optically pumped VCSELs); any other suitable VCSEL construction, architecture, and/or fabrication, as would be understood by one of ordinary skill in the art in light of the examples of the present disclosure; and/or other constructions, architectures, and/or fabrications suitable for the present disclosure may be employed besides a VCSEL, such as—with appropriate architectural modifications, for example, an Edge-Emitting Laser (EEL), a Horizontal Cavity Surface Emitting Laser (HC-SEL), a Quantum Dot Laser (QDL), a Quantum Cascade Laser (QCL), any other form of solid state laser, and/or any light source suitable for examples according to the present disclosure, as would also be understood by one of ordinary skill in the art.

In some examples, one or more eye/face tracking camera(s) may include an image sensor, such as a complementary metal-oxide semiconductor (CMOS) image sensor, a defocused image sensor, a light field sensor, a single photon avalanche diode (SPAD), and/or, in certain implementations, a non-imaging sensor, such as a self-mixing interferometer (SMI) sensor. In some examples, a combined VCSEL/SMI integrated circuit may be employed as both a light source and a sensor for eye/face tracking. In such an example employing a combined VCSEL/SMI integrated circuit as both a light source and a sensor for eye/face tracking, the combined VCSEL/SMI integrated circuit may be disposed inside the frame of near-eye display device 300 and point into a waveguide constituting the display 310 (and lens piece) in order to perform eye/face tracking illumination and sensing.

As mentioned above, in some examples, an outward-facing imaging/projection system of the near-eye display device 300 may include one or more outward pattern projectors, which project a pattern directly on an external environment and/or one or more objects/surfaces in the external environment, and one or more outward-facing camera(s), which may capture one or more reflections of the projected pattern on the one or more objects/surfaces or all or part of the entire external environment. In some examples, such an outward-facing imaging/projection system may serve a variety of purposes, including, but not limited to, profilometry, determining surface patterns/structures of objects in the external environment, determining distances from the user to one or more objects/surfaces in the external environment, determining relative positions of one or more objects/surfaces to each other in the external environment, determining relative velocities of one or more objects/surfaces in the external environment, etc., as would be understood by one of ordinary skill in the art. In some examples, the outward-facing imaging/projection system of the near-eye display device 300 may also be employed to capture images of the external environment. In such examples, the captured images may be processed, for example, by a virtual reality engine to add virtual objects to the captured images or modify physical objects in the captured images, and the processed images may be displayed to the user by the display 310 for augmented reality (AR) applications.

In some examples, the display 310 may include, in whole or in part, and/or be operably connected to, one or more processors, display electronics, and/or display optics similar to the one or more processors, the display electronics 122, and the display optics 124 discussed in reference to FIG. 1, and may be configured to present media or other content to a user, including, e.g., virtual reality (VR), augmented reality (AR) system, and/or any other system capable of presenting media or other content to a user. In some examples, the display 310 may include any number of light sources, such as, e.g., Vertical Cavity Surface Emitting Laser (VCSEL), a liquid crystal display (LCD) display panel, a light-emitting diode (LED) display panel, or an optical display panel (e.g., a waveguide display assembly), etc., and any number of optical components, such as waveguides, gratings, lenses, mirrors, etc., as would be understood by one of ordinary skill in the art.

As mentioned above, in some examples, the display 310 of the near-eye display device 300 may include optics and a waveguide, which may be coupled to a projector (such as, e.g., one or more inward projectors). In some examples, the projector(s) may be disposed inside the frame on the sides of the waveguide constituting the display 310, thereby projecting light into and through the waveguide, which, in turn, projects the light towards the user's eye. In some examples, the display 310 may combine the view of the external environment and artificial reality content (e.g., computer-generated images). In some examples, light from the external environment may traverse a “see-through” region of the waveguide in the display 310 to reach a user's eye (located somewhere within an eye box), while images are also projected for the user to see as part of an augmented reality (AR) display. In such examples, the light of images projected by the projector may be coupled into a transparent substrate of the waveguide, propagate within the waveguide, be coupled with light from the user's actual environment, and be directed out of the waveguide at one or more locations towards a user's eye. In such examples, the waveguide may be geometric, reflective, refractive, polarized, diffractive, and/or holographic, as would be understood of one of ordinary skill in the art, and may use any one or more of macro-optics, micro-optics, and/or nano optics (such as, e.g., metalenses and/or metasurfaces). In some examples, the optics utilized in and/or with the display 310 may include optical polymers, plastic, glass, transparent wafers (e.g., Silicon Carbide (SiC) wafers), amorphous silicon, Silicon Oxide (SiO₂), Silicon Nitride (SiN), Titanium Oxide (TiO), optical nylon, carbon-polymers, and/or any other transparent materials used for such a purpose, as would be understood by one of ordinary skill in the art.

As discussed herein, in some examples, a transparent and/or translucent pupil-replicating waveguide may be utilized so that the user may view the outside world together with images projected into one or both eyes—i.e., “virtual,” projected image-based objects may be superimposed with the outside world view. In some examples, such projected images may include three-dimensional (3D) objects with a simulated parallax, so as to appear immersed into the real-world view (i.e., the projected 3D object(s) would appear to the user as part of the external environment).

In some examples, the near-eye display device 300 may further include various sensors on or within a frame 305, such as, e.g., any number of depth sensors, motion sensors, position sensors, inertial sensors, and/or ambient light sensors. In some examples, the various sensors may include any number of image sensors configured to generate image data representing different fields of views in one or more different directions (which may or may not include outward-facing camera(s)). In some examples, the various sensors may be used as input devices to control or influence the displayed content of the near-eye display device 300, and/or to provide an interactive virtual reality (VR) and/or augmented reality (AR) experience to a user of the near-eye display device 300. In some examples, the various sensors may also be used for stereoscopic imaging or other similar application.

In some examples, the near-eye display device 300 may further include one or more illuminators to project light into a physical environment (which may or may not include, e.g., one or more outward pattern projector(s)). The projected light may be associated with different frequency bands (e.g., visible light, infra-red light, ultra-violet light, etc.), and may serve various purposes. In some examples, the one or more illuminators may be used as locators, such as the one or more locators 126 described above with respect to FIG. 1. In such examples, the near-eye display device 300 may also include an image capture unit (which may or may not include one or more outward-facing camera(s) and/or the external imaging device 150 of FIG. 1), which may capture images of the physical environment in the field of view. In some instances, the captured images may be processed, for example, by a virtual reality engine (such as, e.g., the virtual reality engine 116 of FIG. 1) to add virtual objects to the captured images or modify physical objects in the captured images, and the processed images may be displayed to the user by the display 310 for augmented reality (AR) applications.

In some examples, a majority of electronic components of the near-eye display device 300 in the form of a pair of glasses may be included in the frame 305 of the glasses (e.g., a top bar, a bridge, a rim, a lens, etc.). Examples of such electronic components included in the frame 305 include, but are not limited to, a camera, a sensor, a projector, a speaker, a battery, a microphone, and a battery management unit (BMU). In some examples, a battery management unit (BMU) may be an electronic system that may be used to manage charging and discharging of a battery (e.g., a lead acid battery). In some examples, the battery management unit (BMU) may, among other things, monitor a state of the battery, determine and report data associated with the battery, and provide environmental control(s) for the battery. In some examples, the temples may be provided with a tapering profile, based on design considerations for the specific implementation. In such examples, the tapered temples may be utilized to house various electronic components. For example, in some cases, a microphone or speaker may often be placed towards a rear of a temple arm, near a user's ear, and as such, in many cases, a battery may be more likely to be placed near a front of the temple arm.

Generally speaking, any one or more of the components and/or functionalities described in reference to any of the drawings/figures above may be implemented by hardware, software, and/or any combination thereof, according to examples of the present disclosure. In some examples, the components and/or functionalities may be implemented by any type of application, program, library, script, task, service, process, and/or any type or form of executable instructions executed on hardware such as circuitry that may include digital and/or analog elements (e.g., one or more transistors, logic gates, registers, memory devices, resistive elements, conductive elements, capacitive elements, and/or the like, as would be understood by one of ordinary skill in the art). In some examples, the hardware and data processing components used to implement the various processes, operations, logic, and circuitry described in connection with the examples described herein may be implemented with a general purpose single- and/or multi-chip processor, a single- and/or multi-core processor, a digital signal processor (DSP), an application specific integrated circuit (ASIC), a field programmable gate array (FPGA), or other programmable logic device, discrete gate or transistor logic, discrete hardware components, and/or any combination thereof suitable to perform the functions described herein. A general purpose processor may be any conventional processor, microprocessor, controller, microcontroller, and/or state machine. In some examples, the memory/storage may include one or more components (e.g., random access memory (RAM), read-only memory (ROM), flash or solid state memory, hard disk storage, etc.) for storing data and/or computer-executable instructions for completing and/or facilitating the processing and storage functions described herein. In some examples, the memory/storage may be volatile and/or non-volatile memory, and may include database components, object code components, script components, or any other type of information structure suitable for implementing the various activities and storage functions described herein.

### II. Stray Light Reduction in a Near-Eye Device

As mentioned above, it may be desirable to reduce and/or mitigate stray light in any near-eye device utilizing the an eye/face tracking system. For instance, stray light reduction, mitigation, and/or removal may be beneficial for the eye/face tracking system for any near-eye device, including, e.g., the near-eye display device 120 in FIG. 1, the head-mounted display (HMD) device 200 in FIGS. 2A-2B and/or the near-eye display device 300 in the form of a pair of glasses in FIG. 3, as would be understood by one of ordinary skill in the art. As discussed herein, examples of the present disclosure may be employed in any near-eye device, with or without display capabilities, and/or with or without Virtual Reality (VR) Augmented Reality (AR) and/or Mixed Reality (MR) display capabilities.

“Stray light” as used herein may refer to any light interference, whether originating from external sources (such as, e.g. the sun and/or environment illumination systems) and/or from internal sources (such as, e.g. from an AR/VR display in a near-eye device and/or “ghost images” from the eye/face tracking system). Accordingly, stray light may be cause by reflections off the inner surfaces of optical components, such as, e.g., lenses (including prescription lenses), optical inserts, etc. As discussed herein, stray light may adversely affect the accuracy and reliability of eye/face tracking systems in near-eye devices, including, for example, near-eye AR/VR display devices. For instance, stray light (including, e.g., scattered light) may introduce noise and/or optical artifacts, potentially saturating sensors and/or producing false signals. Accordingly, stray light may compromise an eye/face tracking system's ability to correctly interpret a user's gaze direction and intent, posing a significant challenge to the optimal functionality and/or the user experience of the near-eye device, particularly if it includes an AR/VR interface. For more details concerning stray light and its suppression, see, e.g., Meta's ′239 patent (esp. regarding ghost images), U.S. Pat. No. 11,428,930 entitled “Stray Light Suppression in Eye-Tracking Imaging” and assigned to the present assignee/applicant and/or an affiliate thereof (hereinafter, “Meta's ′930 patent”), and U.S. Pat. No. 10,884,241 entitled “Optical Element for Reducing Stray Infrared Light” and assigned to the present assignee/applicant and/or an affiliate thereof (hereinafter, “Meta's ′241 patent”), all of which are hereby incorporated by reference in their entireties.

As discussed above, stray light in near-eye devices, especially near-eye AR/VR display devices, poses significant challenges to the eye/face tracking systems of those near-eye devices. This is especially problematic when the eye/face tracking sensor (e.g., camera) is positioned such that eye/face tracking light reflected by the eye must pass through multiple optical and/or electro-optical components before reaching the eye/face tracking sensor (such as when, e.g., the eye/face tracking sensor is “behind the lens,” i.e., located on the “other side” of the optical stack, and its lenses, from the user's eye). For example, in a near-eye AR/VR display device similar in construction to the HMD shown in FIGS. 2A-2C, the user's eye may view the display screen through an optical stack of components including, e.g., multiple lenses. In such a near-eye AR/VR display device, the eye/face tracking light source may be embedded within the optical stack and positioned to project its light onto the display screen where a reflective layer reflects the light back through the optical stack to the user's eye, and then the light reflected from the user's eye may also, in turn, have to project back through the optical stack to the eye/face tracking sensor if it is located on the “other side” of the optical stack-thereby producing a number of glares, flares, reflections and unwanted artifacts from the internal surfaces of any and all the optical/electro-optical components comprising the optical stack. All of this stray light will also be received by the eye/face tracking sensor with the desired eye/face tracking light reflected back from the user's eye which originated from the eye/face tracking light source.

As used herein, “behind the lens” and/or “behind-the-lens” may refer, depending on context, to a configuration where the path of the eye/face tracking light projected by the eye/face tracking light source passes through, and/or reflects from, one or more optical/electro-optical components (such as, e.g. passing through the lenses in an optical stack and/or reflecting from a reflective layer in a lens transparent to visible light or a reflective layer in a display screen in an HMD) before reaching the eye/face tracking sensor, thereby providing multiple causes for multiple types of stray light.

Accordingly, the glare, unwanted reflections, optical artifacts, etc. comprising stray light degrade the quality of the eye/face tracking by obscuring the light projected by the eye/face tracking light source and reflected by the eye back to the eye/face tracking sensor. As a result, essential details of the eye may be obscured, making it difficult for the eye/face tracking system to accurately determine, e.g., the direction of the user's gaze. Stray light may complicate the detection of the pupil and glints, a primary method used in eye/face tracking, and stray light artifacts/reflections may be mistaken for the pupil and/or diminish the visibility of the actual pupil, resulting in inaccurate or inconsistent eye/face tracking outcomes. As discussed above, the stray light lens flare and internal reflections, which arise from multiple reflections within the lens elements or between the lens and other components, may produce bright spots or patterns in the captured image, further degrading the quality of the eye/face tracking.

In some examples of the present disclosure, appropriately-disposed IR filters and linearly-polarized IR light sources combined with polarization-sensitive eye/face tracking IR light sensors are described for mitigating the effects of stray light in eye/face tracking systems of near-eye devices. In some examples, the near-eye devices may include, e.g., behind-the-lens eye/face tracking systems, in-frame eye/face tracking systems, glass-embedded eye/face tracking sensors, waveguide-coupled eye/face tracking sensors, etc., as described in greater detail below. In some examples, polarization-controlled illumination may be combined with polarization filtering in behind-the-lens eye/face tracking systems to minimize an amount of stray light that can reach the eye/face tracking camera. In some examples, polarization states may be measured with a polarization-sensitive camera and then the polarization measurements may be employed to suppress stray light at the image processing stage. In some examples, near-eye AR/VR display devices may utilize suitably-positioned IR filters, neutral density filters, and/or polarization-sensitive eye/face tracking light sensors in conjunction with polarized light sources.

Broadly speaking, a near-eye device according to an example of the present disclosure includes a linearly-polarized infrared (IR) light source to project linearly-polarized IR light onto an eye; a polarization-sensitive IR light sensor to receive IR light, including projected linearly-polarized eye/face tracking IR light reflected back from the eye, and to sense a polarization state of the received IR light; and a controller to receive and process the received IR light and the sensed polarization state of the received IR light to generate a two-dimensional (2D) image with reduced stray light to perform eye/face tracking. In some examples, the controller includes a processor and a non-transitory computer-readable memory storing instructions to compute polarization metrics for pixels in a two-dimensional (2D) image formed from the received IR light, using the sensed polarization state of the received IR light; compute a light origin probability map using the computed polarization metrics; reduce stray light in the 2D image using the computed light origin probability map, wherein stray light may be any IR light not originating from the linearly-polarized IR light source; and using the 2D image with reduced stray light to perform eye/face tracking. See, as a non-limiting example, FIG. 13 and its description below.

According to examples of the present disclosure, an IR filter may be utilized to minimize stray light in the IR light received by the polarization-sensitive IR light sensor. In some examples, the IR filter may by any of an in-frame IR filter integrated into a frame of the near-eye device, an in-lens IR filter integrated into a lens of the near-eye device, and/or a coupling IR filter disposed adjacent to a coupling of a waveguide of the near-eye device. See, as non-limiting examples, FIGS. 4A-4C and their descriptions below.

According to examples of the present disclosure, the polarization-sensitive IR light sensor may be disposed behind a lens of the near-eye device. See, as non-limiting examples, FIGS. 6-10A and their descriptions below. In some examples, the polarization-sensitive IR light sensor may be any one or more of a camera, an imaging sensor, or a non-imaging sensor. In some examples, the polarization-sensitive IR light sensor may include a polarization element which has a polarization state orthogonal to a polarization state of a stray light source.

According to examples of the present disclosure, the polarization-sensitive IR light sensor may include a linear polarization filter to filter the received IR light, where the linear polarization filter has a polarization state orthogonal to a polarization state of stray light reflected from any optics in the near-eye device and a grayscale IR camera to capture the filtered received IR light, wherein the linear polarization filter suppresses the stray light reflected from any optics in the near-eye device. See, as a non-limiting example, FIG. 7 and its description below. In some examples, the grayscale IR camera may be an array of light sensors without color filters.

According to examples of the present disclosure, the polarization-sensitive IR light sensor may include an active polarization rotator to switch between polarization states while filtering the received IR light and an IR light sensor to capture successive images of the filtered received IR light at each polarization state of the active polarization rotator. See, as a non-limiting example, FIG. 9 and its description below.

According to examples of the present disclosure, the near-eye device may also include a display screen and an optical stack between the display screen and the eye, where the polarization-sensitive IR light sensor is disposed between the display screen and the optical stack, and the linearly-polarized IR light source is disposed in the optical stack. See, as non-limiting examples, FIGS. 6-10A and their descriptions below.

Broadly speaking, a method for stray light reduction for an eye/face tracking system in a near-eye device according to an example of the present disclosure includes, but is not limited to, the steps of: projecting, by an IR light source, linearly-polarized IR light onto an eye; receiving and sensing, by an IR light sensor of the near-eye device, IR light and a polarization state of the received IR light, wherein the received IR light includes projected linearly-polarized eye/face tracking IR light reflected back from the eye; computing, by a processor, polarization metrics of pixels in a two-dimensional (2D) image formed from the received IR light using the sensed polarization state of the received IR light; computing, by the processor, a light origin probability map using the computed polarization metrics; reducing, by the processor, stray light in the 2D image using the computed light origin probability map, wherein stray light comprises any reflected IR light not originating from the projected linearly-polarized IR light; and performing, by the processor, eye/face tracking using the 2D image with reduced stray light. See, as a non-limiting example, FIG. 13 and its description below. In some examples, the projected linearly-polarized IR light passes through an optical stack of the near-eye device to reach the eye, and the reflection of IR light from the eye passes back through the optical stack to reach the IR light sensor.

According to examples of the present disclosure, the computed polarization metrics may be the angle of linear polarization (AOLP) and/or the degree of linear polarization (DOLP) of pixels in the 2D image. In some examples, other light metrics may be computed of pixels in the 2D image formed from the received IR light, and computing the light origin probability map may also use the computed other light metrics.

According to examples of the present disclosure, the method may further include the step of segmenting, by the processor, the 2D image formed from the received IR light using the computed polarization metrics, where the computing of the light origin probability map uses the segmented 2D image.

According to examples of the present disclosure, the step of receiving and sensing, by the IR light sensor of the near-eye device, the IR light and the polarization state of the received IR light includes capturing the 2D image formed from the received IR light. In other examples, the method may further include the step of forming, by the processor, the 2D image from the received IR light.

Broadly speaking, a near-eye augmented reality/virtual reality (AR/VR) display device according to an example of the present disclosure includes: a display screen to display AR/VR content; an optical stack through which the AR/VR content is displayed to an eye, including an eye/face tracking infrared (IR) light source to project linearly-polarized eye/face tracking IR light onto the eye; a polarization-sensitive eye/face tracking IR light sensor to receive and filter IR light, and an eye/face tracking controller to perform eye/face tracking using the filtered received IR light. More specifically, the polarization-sensitive eye/face tracking IR light sensor filters the received IR light by using a polarization state of the received IR light to pass through any projected linearly-polarized eye/face tracking IR light reflected back from the eye in the received IR light, filters the received IR light by using the polarization state of the received IR light to reduce stray light in the received IR light, and then transmits electronic signals corresponding to an IR light image of the filtered received IR light. The eye/face tracking controller receives and processes the transmitted electronic signals corresponding to the IR light image of the filtered received IR light in order to perform eye/face tracking using the transmitted electronic signals corresponding to the IR light image of the filtered received IR light. The eye/face tracking controller includes a processor and a non-transitory computer-readable memory storing instructions for performing eye/face tracking.

According to examples of the present disclosure, the near-eye AR/VR display device may further include an IR filter to minimize stray light in the IR light received by the polarization-sensitive eye/face tracking IR light sensor. In some examples, the IR filter may be any one or more of an in-frame IR filter integrated into a frame of the near-eye AR/VR display device, an in-lens IR filter integrated into a lens of the near-eye AR/VR display device, and/or a coupling IR filter disposed adjacent to a coupling of a waveguide of the near-eye AR/VR display device.

According to examples of the present disclosure, the linearly-polarized IR light projected onto the eye may be structured IR light and/or unstructured light, where the linearly-polarized IR light may be, for example, an image, a pattern (such as, e.g., a fringe pattern), and/or any other form suitable for eye/face tracking purposes, as would be understood by one of ordinary skill in the art. In some examples, linearly-polarized IR light may be a structured image such as, for example, a pattern (e.g., a fringe pattern) projected onto the eye and/or face by a micro-electromechanical system (MEMS) based scanner reflecting light from the linearly-polarized IR light source.

### A. Placement of IR Filter(s) for Stray Light Reduction in a Near-Eye Device

According to examples of the present disclosure, one or more infrared (IR) filters may be disposed in, on, and/or at various locations/positions on/in a near-eye device to mitigate the effects of stray light. In some examples, one or more IR filters may be disposed in and/or on the frame of a near-eye device (i.e., “in-frame”); in some examples, one or more IR filters may be disposed in and/or on the eye lenses, display, and/or screen of a near-eye device (i.e., “in-lens”); and, in some examples, one or more IR filters may be disposed in, on, and/or with a waveguide of a near-eye device. In some examples, a combination of in-frame, in-lens, and/or waveguide-related IR filters may be utilized. In some examples, one or more IR filters may be utilized with the eye/face tracking configurations described in Sect. II.B below.

In some examples, one or more IR filters may include an IR cut-off filter, sometimes called a heat-absorbing filter and/or just an IR filter, which may be designed to block near-infrared (NIR) and/or infrared (IR) spectrum light while passing visible light. In some examples, blocked radiation may include a range of wavelengths from about 750 nm to about 1,000 μm, but also may include NIR ranges going down to 700 nm. As used herein, “IR” and/or “infrared” may refer to any range of NIR/IR, from wavelengths of about 700 nm to 1,000 μm, depending on the context, as would be understood by one of ordinary skill in the art. See the discussion of IR cut-off filters further below, in reference to FIG. 5.

In some examples, one or more IR filters may be integrated with anti-reflection and/or anti-scratch filters, which may enhance functionality and durability, in addition to blocking and/or attenuating infrared radiation (which, e.g., protects the eyes from potential IR-induced damage). The integration of one or more IR filters, one or more anti-reflection coatings, and/or one or more anti-scratch coatings/layer into lens/optics for a near-eye devices may be accomplished using advanced techniques in thin-film deposition technologies and materials science. For instance, vacuum deposition, spin-coating, and dip-coating processes may allow for consistent and high-quality application of coatings in large scale manufacturing.

In some examples, IR-absorbing compounds and/or dyes may be embedded in the lens material of a near-eye device. In some examples, a thin-film interference filter, which works by reflecting specific IR wavelengths while allowing visible light to pass through, may be applied to a surface of the lens material of a near-eye device.

In examples where an anti-reflection coating is used, the anti-reflection coating may be a multi-layered thin film, which may be applied through vacuum deposition. In such examples, by carefully selecting materials with varying refractive indices and controlling the thickness of each layer, the resulting multi-layer thin film coating may cause the destructive interference of reflected IR light waves, effectively reducing IR reflections while also enhancing visible light transmission.

In examples where an anti-scratch coating is used, the anti-scratch coating may be composed of a hard, durable polymer-like silica-based coating, and may shield the underlying functional coatings from minor abrasions and scratches. In such examples, the deposition process may involve spin-coating or dip-coating, where the lens is immersed in or spun within a liquid precursor, followed by a curing process to harden the coating. By layering these coatings, the resulting lens module may not only offer protection against IR radiation and reduced glare but may also ensure resistance against everyday wear and tear, thereby maintaining the integrity of the lens and its coatings.

If a frame is transparent or translucent, the environment light may be blocked with IR cut-filters on the frame and/or on the lenses to maintain the aesthetic appearance while increasing performance through reduction of stray light that can reach the eye/face tracking sensor(s). In examples where the frame is opaque, frame-embedded eye/face tracking sensor(s) may be fitted with an on-sensor spectral filter. In some examples, eye/face tracking sensor(s) embedded in glass may employ one or more localized IR filters, which may be disposed behind the embedded eye/face tracking sensor(s). In other examples, an optical glue holding the eye/face tracking sensor(s) in place may have IR-absorbing properties to prevent locally scattered light from reaching the eye/face tracking sensor(s).

In examples where the near-eye device employs a waveguide, the coupling layer of the waveguide may have a localized spectral filter behind the coupling points where the IR light is inserted (coupled) into the waveguide to prevent the IR light from the environment being coupled into waveguide and overwhelming the signal. In such examples, the localized spectral filter may be utilized in addition, or as an alternative, to in-frame filters and/or in-lens filters.

FIGS. 4A, 4B, and 4C illustrate different approaches to the placement of one or more IR filters to mitigate stray light effects according to various examples of the present disclosure: FIG. 4A illustrates an approach where both the eye/face tracking camera and the IR filter may be disposed in the frame of the near-eye device, according to an example of the present disclosure; FIG. 4B illustrates an approach where both the eye/face tracking camera and the IR filter may be disposed in the eye lens of the near-eye device, according to an example of the present disclosure; while FIG. 4C illustrates an approach where the IR filter is disposed on and/or in a waveguide of the near-eye device, according to an example of the present disclosure. In other words, the eye/face tracking camera and stray light filter are “in-frame” in FIG. 4A, the eye/face tracking camera and stray light filter are “in-lens” in FIG. 4B, and the eye/face tracking camera and stray light filter are coupled with a waveguide for a near-eye device in FIG. 4C.

Although only a single eye/face tracking camera and single filter are shown in FIGS. 4A and 4B (and a single eye/face tracking camera and two filters are shown in FIG. 4C), any number of eye/face tracking cameras and/or filters may be employed in examples according to the present disclosure, as would be understood by one of ordinary skill in the art. Although the eye/face tracking camera and filter are shown in specific locations in FIGS. 4A and 4B, any suitable location or locations may be utilized for placement, as would be understood by one of ordinary skill in the art. FIG. 4C is a schematic/conceptual block diagram, and the relative positions of components are not representative of any particular location (as depicted therein), but rather indicative of functionality, as explained in detail below.

Both FIGS. 4A and 4B shows a near-eye device in the form of a pair of glasses similar to that shown in FIG. 3, and the near-eye devices in FIGS. 4A-4B may share any and all of the same and/or similar components as discussed above in reference to FIG. 3, which may operate/function in a similar manner. However, examples of the present disclosure are not so limited, and the in-frame and/or in-lens examples may be implemented in an HMD device, such as the HMD device 200 discussed and described in reference to FIGS. 2A-2C, and/or any other type of near-eye device, such as the near-eye device 120 described in reference to FIG. 1. Moreover, multiple in-lens and/or in-frame filters may be utilized, as well as any combination of the two, in any kind of near-eye device in accordance with examples of the present disclosure. As discussed in further detail below, FIG. 4C shows only the waveguide portion of a near-eye device, which may be a part of any type or kind of near-eye device, whether, for example, a near-eye device in the form of a pair of glasses similar to that shown in FIG. 3, an HMD device, such as the HMD device 200 discussed and described in reference to FIGS. 2A-2C, and/or any other type of near-eye device, such as the near-eye device 120 described in reference to FIG. 1.

FIG. 4A is a frontal perspective view of a near-eye display device 400A in the form of a pair of glasses (or other similar eyewear) with an in-frame eye/face tracking camera and IR filter, according to an example. As shown in FIG. 4A, the near-eye display device 400A may include a frame 402, a display 404, an IR projector 405, an in-frame eye/face tracking camera 406 with a built-in IR filter 408, and a controller 430A. In some examples, the near-eye display device 400A may be an implementation of the near-eye display device 120 of FIG. 1, and/or the near-eye display device 300 of FIG. 3, and may be configured to operate as a VR/AR system, and/or as part of any such content system that uses displays and/or wearables, or any combination thereof. In some examples, the near-eye display device 400A may include an additional inward-facing and/or an outward-facing projection systems, such as are described and discussed elsewhere herein, to which examples of the present disclosure may be applied.

In FIG. 4A, the display 404 may be configured to present media or other content to a user. In some examples, the display 404 may include electronic components and/or optical components, similar in form and function as those discussed in reference to the display electronics 122 and/or the display optics 124 in the near-eye device 120 of FIG. 1, the display 210 of FIGS. 2A-2C, the display 310 of FIG. 310, and/or any other display components (electrical, electronic, and/or optical) described and/or mentioned herein. For instance, as described above with respect to the near-eye device 120 of FIG. 1, the display 404 may include a liquid crystal display (LCD) display panel, a light-emitting diode (LED) display panel, and/or an optical display panel (e.g., a waveguide display assembly). In some examples, the display 404 may also include any number of optical components, such as waveguides, gratings, lenses, mirrors, etc. In some examples, the display 404 may include a projector; in other examples, the display 404 in the near-eye display device 400A may be replaced, in whole or in part, by a projector system which may project images into the user's eye(s).

In FIG. 4A, the IR projector 405 may be disposed such that the IR projector 405 projects a pattern, image, and/or other structured and/or unstructured light of the IR spectrum upon the user's eye and/or surrounding facial tissue for use in, e.g., eye/face tracking. In some examples, the IR projector 405 may project such IR spectral light indirectly, such as into a lens waveguide, and/or at a mirror, and/or at a rotating beam splitter, etc., which ultimately directs the IR light upon the user's eye. As such, although depicted in a specific location in FIG. 4A, the IR projector 405, depending on the implementation of the present disclosure, may be disposed in, at, and/or on practically any location of the near-eye display device 400A. For example, the IR projector 405 may be disposed in the eye lens/display 404 itself as part of an array of miniature translucent/transparent IR projecting electronic components, and/or on the temple arms of the frame 402 aimed towards a reflecting apparatus which re-directs the IR light to the user's eye, etc., as would be understood by one of ordinary skill in the art.

In FIG. 4A, the in-frame eye/face tracking camera 406 may be disposed such that the in-frame eye/face tracking camera 406 receives IR light reflected from the user's eye, images and/or otherwise senses the reflected IR light, and may produce electrical, electronic, and/or other signals representing the imaged/sensed IR light, which may be used for, e.g., eye/face tracking purposes. Although depicted in a specific location in FIG. 4A, the in-frame eye/face tracking camera 406 may be disposed anywhere in and/or on the frame 402 of the near-eye display device 400A. In other examples, the eye/face tracking camera may be disposed in the lens itself (such as, e.g., in FIG. 4B described below).

In FIG. 4A, the built-in filter 408 of the in-frame eye/face tracking camera 406 may be an IR filter utilized, at least in part, for mitigating the effects of stray light. In some examples, the built-in filter 408 of the in-frame eye/face tracking camera 406 may be a spectral filter; in other examples, the built-in filter 408 of the in-frame eye/face tracking camera 406 may be implemented, in whole or part, by signal processing hardware, software, firmware, and/or any combination thereof (accordingly, in such examples, the built-in filter may be implemented, in whole or part, by operations executed by the controller 430A). In some examples, the built-in filter 408 may be a lens integrated into the in-frame camera 406; in other examples, the built-in filter 408 may be integrated into the frame 402 such that the reflected IR light must pass therethrough before reaching the in-frame eye/face tracking camera 406.

In FIG. 4A, the controller 430A may control and/or be communicatively connected to any one or more of the display 404, the IR projector 405, the in-frame eye/face tracking camera 406, the built-in IR filter 408, and/or any other components not shown in FIG. 4A. In some examples, the controller 430A may perform one, more, and/or all of the eye/face tracking operations for the near-eye display device 400A. In some examples, the controller 430A may be one or more of the eye/face tracking unit 130 and/or eye/face tracking module 118 in FIG. 1 as described above, and/or any other processing or controlling module which may be used for eye/face tracking operations in a near-eye device, as would be understood by one of ordinary skill in the art. In some examples, the controller 430A may include one or more processors and one or more memories (and/or be communicatively connected to one or more memories), where the one or more memories may be any number of non-transitory computer-readable storage media which may store instructions that, when executed by the one or more processors, may cause the one or more processors to perform any of the functions described herein and/or to control any of the components described herein, as discussed more fully below in reference to the controller 430C in FIG. 4C.

FIG. 4B is a frontal perspective view of a near-eye display 400B in the form of a pair of glasses (or other similar eyewear) with an in-lens camera and localized filter, according to an example. As shown in FIG. 4B, the near-eye display device 400B may include a frame 402, a display 404, an IR projector 405, an in-lens eye/face tracking camera 426, an in-lens localized IR filter 428, and a controller 430B. In some examples, the near-eye display device 400B may be an implementation of the near-eye display device 120 of FIG. 1, and/or the near-eye display device 300 of FIG. 3, and may be configured to operate as a virtual reality (VR) system, an augmented reality (AR) system, and/or as part of any such content system that uses displays or wearables, or any combination thereof. In some examples, the near-eye display device 400B may include an inward-facing and/or an outward-facing projection systems, such as are described and discussed elsewhere herein, to which examples of the present disclosure may be applied.

In FIG. 4B, the display 404 may be configured similarly as the display 404 in FIG. 4A and the IR projector 405 may be configured similarly as the IR projector 405 in FIG. 4A.

In FIG. 4B, the in-lens eye/face tracking camera 426 may be disposed such that the in-lens eye/face tracking camera 426 receives IR light reflected from the user's eye, images and/or otherwise senses the reflected IR light, and may produce electrical, electronic, and/or other signals representing the imaged/sensed IR light, which may be used for, e.g., eye/face tracking purposes. Being disposed in and/or in the lens, the in-lens eye/face tracking camera 426 may be a miniature translucent/transparent imaging/sensing electronic component and/or may include an array of miniature translucent/transparent imaging/sensing electronic components.

In FIG. 4B, the in-lens localized IR filter 428 may be an IR filter utilized, at least in part, for mitigating the effects of stray light. In some examples, the in-lens localized IR filter 428 may be a spectral filter; in other examples, the in-lens localized IR filter 428 may be implemented, in whole or part, by signal processing hardware, software, firmware, and/or any combination thereof (accordingly, in such examples, the built-in filter may be implemented, in whole or part, by operations executed by the controller 430B). In some examples, the in-lens localized IR filter 428 may be a lens integrated on and/or in the in-lens eye/face tracking camera 426.

In some examples, the in-lens localized IR filter 428 may be disposed on and/or in the lens of the near-eye display device 400B “behind” the in-lens eye/face tracking camera 426—i.e., on the surface of the lens facing away from the user and towards the external environment and/or in any internal layer of the lens between the in-lens eye/face tracking camera 426 and the external environment. In other words, the in-lens localized IR filter 428 should be in “back” of the in-lens eye/face tracking camera 426 such that the in-lens localized IR filter 428 does not interfere with the in-lens eye/face tracking camera 426 receiving IR reflections from the user's eye(s).

As shown in FIG. 4B, the in-lens localized IR filter 428 may be disposed around the in-lens eye/face tracking camera 426 in either a whole circular shape if “behind” the in-lens eye/face tracking camera 426 or a toroidal shape with an IR-transmissive “hole” such that the in-lens eye/face tracking camera 426 may receive IR reflections from the user's eye(s) through the hole if the in-lens localized IR filter 428 is in “front” of the in-lens eye/face tracking camera 426 (i.e., on the side facing the user's eye(s)).

In some examples, the in-lens localized IR filter 428 may be implemented by mixing one of more layers of the lens with a dye and/or any IR-opaque material during fabrication. In some examples, the in-lens localized IR filter 428 may be implemented by disposing one of more layers of a thin film of any IR-opaque material within the lens during fabrication (and/or on the outer/external surface of the lens and/or the inner/eye surface of the lens if a suitable “hole” or “gap” is provided for the in-lens eye/face tracking camera 426 to receive IR reflections from the user's eye(s). In some examples, the in-lens localized IR filter 428 may be integrated into an anti-scratch coating and/or an anti-reflective coating applied on or fabricated in the lens.

In other examples, the optical glue holding the in-lens eye/face tracking camera 426 in place within the lens may have IR-absorbing properties and thus may serve, in form and/or function, as the in-lens localized IR filter 428. In such examples, the IR-filtering optical glue may be employed alone or with one or more other in-lens localized IR filters.

In FIG. 4B, the controller 430B may control and/or be communicatively connected to any one or more of the display 404, the IR projector 405, the in-lens eye/face tracking camera 426, the in-lens localized IR filter 428, and/or any other components not shown in FIG. 4B. In some examples, the controller 430B may perform one, more, and/or all of the eye/face tracking operations for the near-eye display device 400B. In some examples, the controller 430B may be one or more of the eye/face tracking unit 130 and/or eye/face tracking module 118 in FIG. 1 as described above, and/or any other processing or controlling module which may be used for eye/face tracking operations in a near-eye device, as would be understood by one of ordinary skill in the art. In some examples, the controller 430B may include one or more processors and one or more memories (and/or be communicatively connected to one or more memories), where the one or more memories may be any number of non-transitory computer-readable storage media which may store instructions that, when executed by the one or more processors, may cause the one or more processors to perform any of the functions described herein and/or to control any of the components described herein, as discussed more fully below in reference to the controller 430C in FIG. 4C.

FIG. 4C is a conceptual/schematic block diagram of a waveguide-based configuration used in a near-eye device, where an IR filter may be disposed on and/or in the waveguide, according to an example of the present disclosure. FIG. 4C is provided to illustrate a general explanation herein of examples of applying IR filters in accordance with examples of the present disclosure to waveguides employed in near-eye devices, and omits aspects, features, and/or components not germane to a general explanation of examples of applying IR filters to waveguides employed in near-eye devices, according to examples of the present disclosure, as would be understood by one of ordinary skill in the art. For example, the IR projection system is not shown in FIG. 4C, but rather only the IR reflections from the user's eye (as arrows). Moreover, the components shown in FIG. 4C are not shown in accurate aspect and/or ratio of relative sizes (e.g., the relative sizes, shapes, and/or locations of the user's eye, the waveguide, the respective gratings, the IR filter(s), the eye/face tracking camera, the controller, etc., in FIG. 4C may in no way approximate the relative sizes, relative locations, and/or relative dimensions of those components in specific implementations and/or examples). In other words, FIG. 4C is intended to illustrate general concepts related to examples of the present disclosure, and is not intended to illustrate the sizes, proportions, relative aspects, etc., of the specific components shown in FIG. 4C, as would be understood by one of ordinary skill in the art.

FIG. 4C is a cross-sectional view of a conceptual/schematic block diagram of a waveguide-based configuration 4000 used in a near-eye device, with one or more IR filters 438 disposed on the periphery of the in-coupling 411 of a waveguide 410 and an eye/face tracking camera 436 disposed such that the eye/face tracking camera 436 receives the IR reflections from the out-coupling 419 of the waveguide 410, according to an example. In some examples, the near-eye device employing the waveguide-based configuration 4000 of FIG. 4C may be an implementation of the near-eye display device 120 of FIG. 1, the HMD device 200 of FIGS. 2A-2C, and/or the near-eye display device 300 of FIG. 3, and may be configured to operate as a VR/AR system, and/or as part of any such content system that uses displays and/or wearables, or any combination thereof. In some examples, the near-eye device employing the waveguide-based configuration 4000 of FIG. 4C may include an additional inward-facing and/or an outward-facing projection systems, such as are described and discussed elsewhere herein, to which examples of the present disclosure may be applied.

In FIG. 4C, the arrows represent the path(s) of the IR reflections from a user's eye 490 into, through, and out of the waveguide 410 to the eye/face tracking camera 436. More specifically, the IR reflections from the user's eye 490 enter through the in-coupling 411 of the waveguide 410, where one or more IR filters 438 may be disposed on the outer circumference of the in-coupling 411. Because FIG. 4C is a cross-section, the one or more IR filters 438 appears as two separate IR filters disposed on opposite sides of the in-coupling 411, which is a possible implementation, but the one or more IR filters 438 may be a single IR filter encircling or otherwise circumscribing the in-coupling 411, or the one or more IR filters 438 may be a circular array of multiple IR filters encircling or otherwise circumscribing the in-coupling 411.

As shown in FIG. 4C, after entering the waveguide 410 through the in-coupling 411, the IR reflections are reflected, refracted, and/or otherwise re-directed by gratings such as Polarization Volumetric Hologram-based (PVH) gratings 413 to the inner surface of the waveguide 410, on which the IR reflections are reflected, refracted, and/or otherwise re-directed to the PVH gratings 417 which, in turn, reflect, refract, and/or otherwise re-direct the IR reflections to the out-coupling 419, where the IR reflections are ultimately received by the eye/face tracking camera 436.

Accordingly, the one or more IR filters 438 may attenuate any IR reflections from outside the pupil area (circled in the user's eye 490 in FIG. 4C), thereby mitigating the effects of stray light and/or enabling the focus of attention on one of the main determinants of eye/face tracking (i.e., the pupil area). In some examples, the one or more IR filters 438 may be disposed in one or more locations in, on, or outside the waveguide 410 to attenuate any stray IR light from the external environment overwhelming and/or otherwise interfering with the eye/face tracking using the IR reflections from the user's eye 490. In some examples, the one or more IR filters 438 in FIG. 4C may be utilized with or without one or more in-frame IR filter(s) such as shown in FIG. 4A and/or one or more in-lens IR filter(s) such as shown in FIG. 4B.

In some examples, one or more IR projectors (not shown in FIG. 4C) may be disposed in, on, or outside the waveguide 410 such that the IR light may be projected upon the eye 490. In some examples, the reflections from the eye 490 of the IR light projected by the one or more IR projectors (not shown in FIG. 4C) may be utilized for one or more eye/face tracking functions such as described herein (e.g., such as above in reference to FIGS. 1-3).

In some examples, a neutral density filter may be disposed adjacent to a waveguide coupling to both minimize stray light and improve the industrial design of the near-eye device. In some examples, the neutral density filter may be utilized in addition to the one or more IR filters discussed herein; in other examples, the neutral density filter may be utilized alone. In some examples, the neutral density filter may include multiple neutral density filters disposed at multiple locations (e.g., at one or more different in-couplings and/or out-couplings of the waveguide). In some examples, the neutral density filter may be disposed next to one or more in-couplings, such as an in-coupling for the projection of eye/face tracking IR light, an in-coupling for the reflection of IR light from the eye (such as, e.g., the in-coupling 411 of FIG. 4C), and/or another type of in-coupling. In some examples, the neutral density filter may be disposed next to one or more out-couplings, such as an out-coupling for the projection of eye/face tracking IR light onto the eye, an out-coupling for the reflection of IR light back from the eye (such as, e.g., the out-coupling 419 of FIG. 4C), and/or another type of out-coupling. In some examples, the neutral density filter may be disposed behind the waveguide coupling.

In some examples, a neutral density filter may provide several advantages, including, e.g.:
Stray Light Reduction: the neutral density filter may help reduce the intensity of unwanted light (i.e., stray light) that, for example, may enter the waveguide from the external environment. By attenuating stray light, the neutral density filter may help ensure the eye/face tracking system receives a clearer signal with less interference, thereby improving the accuracy and reliability of the eye/face tracking.
Reduction of Waveguide Coupling Light Dispersion: although coupling light dispersion may also be considered a type of stray light in its broadest sense (as used herein), it should be noted separately that the neutral density filter being disposed adjacent to the waveguide coupling may reduce the “rainbow” visible light effect which may occur due to the dispersion of light by the waveguide coupling, thereby minimizing this visually distracting light artifact and improving the overall aesthetics of the near-eye device. Accordingly, the overall appearance of the near-eye device may be enhanced, and its industrial design improved, as the use of the neutral density filter may contribute to a more streamlined and visually appealing appearance for the near-eye device, thereby making it more attractive to both users of the near-eye device and outside observers of the near-eye device.

In FIG. 4C, the eye/face tracking camera 436 may be disposed such that the eye/face tracking camera 436 receives the reflected IR light from the out-coupling 419 of the waveguide 410, images and/or otherwise senses the reflected IR light, and may produce electrical, electronic, and/or other signals representing the imaged/sensed IR light, which may be used for, e.g., eye/face tracking purposes. As would be understood by one of ordinary skill in the art, the eye/face tracking camera 436 may be disposed anywhere in and/or on a near-eye device employing the waveguide-based configuration 4000 of FIG. 4C, as long as the eye/face tracking camera 436 can receive the IR reflections from the out-coupling 419 of the waveguide 410.

In FIG. 4C, the controller 430C may control and/or be communicatively connected to the eye/face tracking camera 436 and/or any active electronic and/or optical components (which may include, e.g., the waveguide 410, the in-coupling 411, the one or more IR filters 438, the gratings 413 & 417, etc.), and/or any other components not shown in FIG. 4C (such as the IR projection system, any image display projection system, etc.). In some examples, the controller 430C may perform one, more, and/or all of the eye/face tracking operations for the near-eye device utilizing waveguide-based configuration 4000, as would be understood by one of ordinary skill in the art. In some examples, the controller 430C may be one or more of the eye/face tracking unit 130 and/or eye/face tracking module 118 in FIG. 1 as described above, and/or any other processing or controlling module which may be used for eye/face tracking operations in a near-eye device, as would be understood by one of ordinary skill in the art.

As shown in FIG. 4C, and as referred to above in relation to controllers 430A/B in FIGS. 4A/4B, the controller 430C may include a processor 433C and a memory 435C (and/or be communicatively connected to a memory), where the memory 435C may be any number of non-transitory computer-readable storage media which may store instructions that, when executed by the processor 433C, may cause the processor 433C to perform any of the functions described herein and/or to control any of the components described herein. As used herein, “media” should be understood as the term is used in typical English parlance, i.e., as including both the singular (“medium”) and the plural (“media”).

In some examples, the processor 433C may include multiple processors; in other examples, the processor 433C may be integrated into one or more other processors in the near-eye device (e.g., multi-tasking processors). In some examples, the processor 433C may include a general purpose single- and/or multi-chip processor, a single- and/or multi-core processor, a digital signal processor (DSP), an application specific integrated circuit (ASIC), a field programmable gate array (FPGA), or other programmable logic device, discrete gate or transistor logic, discrete hardware components, and/or any combination thereof suitable to perform the functions described herein. A general purpose processor may be any conventional processor, microprocessor, controller, microcontroller, and/or state machine. In some examples, the processor 433C may include any of the eye/face tracking unit 130 and/or eye/face tracking module 118 in FIG. 1; any other one or more processing components described in Sect. I; and/or any other suitable one or more processing components, as would be understood by one of ordinary skill in the art, in light of the present disclosure.

In some examples, the memory 435C may include multiple memories; in other examples, the memory 435C may be integrated into one or more other memories in the near-eye device. As stated above, the memory 435C may be a non-transitory computer-readable storage media which storing instructions that, when executed, cause the processor 433C to perform any of the functions described herein and/or to control any of the components described herein. In some examples, the non-transitory computer-readable storage media may include one or more components (e.g., random access memory (RAM), read-only memory (ROM), flash or solid state memory, hard disk storage, etc.) for storing data and/or computer-executable instructions for completing and/or facilitating the processing and storage functions described herein. In some examples, the memory/storage may be volatile and/or non-volatile memory, and may include database components, object code components, script components, or any other type of information structure suitable for implementing the various activities and storage functions described herein. In some examples, the non-transitory computer-readable storage media may include any other one or more memory storage components described in Sect. I and/or any other suitable one or more memory storage components, as would be understood by one of ordinary skill in the art, in light of the present disclosure.

FIG. 5 is a graphic 500 which illustrates the relationship between optical density and wavelength for an IR cut-filter which may be used for stray light mitigation in a near-eye device, according to an example of the present disclosure. The graph 500 shows optical density, a measure of light absorption, across wavelength, ranging from the ultraviolet (UV), through the visible, to the infrared (IR). In the visible range (approximately 380 nm to 750 nm) in the center of the graphic 500, the optical density is low (as indicated by the dotted marking, i.e., the visible range is the dotted area in the middle of the graphic 500), allowing visible light to pass through with minimal attenuation. As the wavelength increases into the IR range, the optical density rises sharply, resulting in the increasing blocking of IR light (the higher optical density is indicated by the reverse cross-hatched marking, i.e., the IR range is shown as the reverse cross-hatched area at the right end of the graphic 500). This performance of the IR cut-filter may be very beneficial for reducing the stray IR light that can interfere with eye/face tracking systems, thereby enhancing the accuracy and reliability of eye/face tracking systems in near-eye devices. The IR cut-filter may be integrated into the frame (e.g., an in-frame IR cut-filter) or a lens (e.g., an in-lens IR cut-filter) of a near-eye device, thereby maintaining the integrity of the near-eye device's design while also improving its functionality by minimizing unwanted IR light interference (i.e., stray light).

### B. Eye/Face Tracking Configurations for Stray Light Reduction in a Near-Eye Device

To reduce stray light effects in eye/face tracking systems in near-eye devices (such as, e.g., near-eye AR/VR display devices with behind-the-lens eye/face tracking systems), examples of combinations of polarization sensitive light sensors and polarized light sources are described below. In some examples, the polarization-controlled illumination and polarization filtering may be combined in behind-the-lens eye/face tracking systems to minimize the amount of stray light that can reach the eye/face tracking light sensor. In some examples, a polarization-sensitive eye/face tracking light sensor may sense polarization states and then the sensed polarization state data may be utilized at the image processing stage to minimize stray light.

Generally speaking, approaches to optical design for reducing stray light in eye/face tracking systems include, for example, anti-reflective coatings applied to lens surfaces to reduce reflections, thereby minimizing the amount of stray light entering the eye/face tracking light sensor; the reduction of air-to-glass interfaces to reduce the probability of internal reflections; the use of aspherical lens elements to help reduce lens flare and other aberrations; the introduction of baffles or shields within the optical path to block unwanted light from reaching the eye/face tracking light sensor; the strategic placement of components to prevent light from external sources or other internal components from causing interference; and the blackening of the edges of lens elements and other internal components may also absorb stray light, preventing it from reflecting back into the optical path.

Generally speaking, approaches to system design for reducing stray light in eye/face tracking systems include, for example, implementing a dynamic calibration system that continuously adjusts based on the detected stray light conditions and helps maintain accurate eye/face tracking even in varying lighting conditions; and advanced image processing approaches may be employed to identify and compensate for the effects of stray light. For example, an image processing algorithm may be designed to distinguish between genuine pupil reflections and artifacts caused by stray light. In other examples, the position of the eye/face tracking light sensor may be optimized to reduce its exposure to stray light. As mentioned above, physical shields or barriers may be utilized around the eye/face tracking light sensor to block out any potential sources of stray light. Furthermore, feedback mechanisms may be implemented to generate an alert when stray light is affecting the eye/face tracking performance. In some examples, the alert may prompt the user to adjust the headset or their position/orientation within the external environment to improve eye/face tracking performance.

When light reflects off a non-metallic surface, such as plastic or glass, its polarization state can change. The change is influenced by the angle of incidence and the material's refractive index. The phenomenon responsible for this alteration in polarization state upon reflection is termed “Brewster's angle” or “the polarizing angle,” at which light reflecting off the surface becomes entirely linearly polarized parallel to the surface. This means that the reflected light will have its electric field oscillating in a direction parallel to the reflecting surface, with no component perpendicular to it. The transmitted light, in contrast, will be partially polarized in a direction perpendicular to the reflected light.

$${Θ}_{B} = arc tan ( {n}_{1} / {n}_{2} ) \qquad ( 1 )$$

where Θ_{B} is the Brewster angle, n₁ is the refractive index of the first medium, and n₂ is the refractive index of the second medium.

At angles of incidence below Brewster's angle, the reflected light is only partially polarized. As the angle of incidence nears Brewster's angle, the degree of polarization increases. Above Brewster's angle, the reflected light remains polarized, but not as purely as right at Brewster's angle. The exact value of Brewster's angle is contingent on the refractive index of the material.

When polarized light is incident on a surface, the behavior of the reflected light depends on the polarization state of the incoming light; two special cases are of interest:
S-Polarized Light: when S-polarized light is incident on a surface, the electric field of the light oscillates perpendicular to the plane of incidence (the plane defined by the incident ray and the surface normal). Upon reflection, the light remains S-polarized, maintaining its electric field oscillation perpendicular to the plane of incidence. The reflectance (or reflection coefficient) for S-polarized light varies with the angle of incidence. At Brewster's angle, the reflectance for S-polarized light is non-zero and is typically higher than that for P-polarized light.
P-Polarized Light: when P-polarized light is incident on a surface, the electric field of the light oscillates parallel to the plane of incidence. Upon reflection, the light remains P-polarized, maintaining its electric field oscillation parallel to the plane of incidence. The reflectance (or reflection coefficient) for P-polarized light also varies with the angle of incidence. Notably, at Brewster's angle, the reflectance for P-polarized light becomes zero, meaning that no P-polarized light is reflected at this angle. This is the basis for the phenomenon where light reflecting off a surface at Brewster's angle becomes fully S-polarized.

As mentioned herein, linearly polarized light may be used strategically for illumination to counteract stray light. By introducing a well-defined polarization state, the behavior of light may be precisely predicted and controlled upon reflection. This predictability may be used when considering the minimized reflection of S-polarized light on surfaces at Brewster's angle, a property that may be harnessed to suppress unwanted reflections from non-metallic entities like plastic or glass. Furthermore, the inherent contrast enhancement provided by linearly polarized illumination, when paired with a suitably oriented polarizer, allows for a stark differentiation between desired and undesired light paths, thereby refining image clarity.

FIGS. 6 through 10A illustrate various light sources, optical assembly, and eye/face tracking sensor configurations to mitigate stray light in a near-eye device, according to various examples. FIGS. 6, 7, 8, 9, and 10A are provided to illustrate general explanations herein of various examples of the present disclosure, and omit aspects, features, and/or components not germane to these general explanations of various examples of the present disclosure, as would be understood by one of ordinary skill in the art. Accordingly, the components shown in any of FIGS. 6, 7, 8, 9, and/or 10A may not be shown in accurate aspect and/or ratio of relative sizes (e.g., the relative sizes, shapes, and/or locations of the sensor(s), optical elements/lenses, display screen(s), light sources, controller(s), the optical stacks generally, etc., in FIGS. 6, 7, 8, 9, and/or 10A may in no way approximate the sizes, relative locations, and/or relative dimensions of those components and/or structures in specific implementations and/or examples). In other words, FIGS. 6, 7, 8, 9, and/or 10A are intended to illustrate general concepts related to various examples of the present disclosure, and are not intended to illustrate the sizes, proportions, relative aspects, etc., of the specific components shown in FIGS. 6, 7, 8, 9, and/or 10A, as would be understood by one of ordinary skill in the art.

Each of FIGS. 6, 7, 8, 9, and 10A show an eye looking through an optical stack at a display screen which may show images, which may include, for example, any of AR, VR, and/or MR content. One or more IR light sources for illuminating the eye for purposes of eye/face tracking may be integrated into the optical stack, where the IR light projected by the one or more IR light sources may be polarized according to examples of the present disclosure. One or more IR light sensors for eye/face tracking may be disposed to receive the reflections of the IR light from the eye, where the one or more IR light sensors may be polarization-sensitive according to examples of the present disclosure. In some examples, one or more optical, electro-optical, and/or electro-magnetic components may also be utilized to manipulate and/or otherwise affect the polarization of the IR light being used for eye/face tracking including, but not limited to, for example, filters, retarders, rotators, polarizers, depolarizers, etc., as would be understood by one of ordinary skill in the art. While the optical stack/display screen configuration shown in each of FIGS. 6, 7, 8, 9, and 10A may seem suited for an HMD display such as, e.g., the HMD display 200 in FIGS. 2A-2C, examples of the present disclosure are not so limited, and may be implemented, with suitable modifications, to other near-eye devices, such as the near-eye device 300 in FIG. 3 and/or any other near-eye device, as would be understood by one of ordinary skill in the art.

FIG. 6 is a block diagram illustrating a configuration 600 of one or more linearly-polarized eye/face tracking IR light sources for illuminating an eye and one or more polarization-sensitive eye/face tracking IR sensors for receiving reflections of IR light from the eye, according to an example of the present disclosure. More specifically, configuration 600 may include linearly-polarized eye/face tracking IR light sources 605a and 605b integrated into an optical stack 610 (which may, in turn, include a 1^{st} lens 611 and a 2^{nd} lens 612), a polarization-sensitive eye/face tracking IR sensor 615, a display screen 620, and a controller 630 (which may, in turn, include processor 633 and/or memory 635). The one or more polarization-sensitive eye/face tracking IR sensors may receive stray light in addition to reflections of the linearly-polarized IR light.

In FIG. 6, the linearly-polarized eye/face tracking IR light sources 605a and 605b illuminate the eye, the polarization-sensitive eye/face tracking IR sensor 615 receives IR reflections from the eye, and the resulting sensor data, including the polarization sensor data, may be used for eye/face tracking in this and similarly in FIGS. 7, 8, 9, and 10A. See, e.g., U.S. Pat. No. 10,108,261 entitled “Eye Tracking based on Light Polarization,” which shares an inventor with the present application and is presently assigned to the present assignee/applicant and/or an affiliate thereof (hereinafter, “Meta's ′261 patent”) and “STRUCTURED POLARIZATION-BASED EYE TRACKING,” Technical Disclosure Commons (Aug. 16, 2023), available at https://www.tdcommons.org/dpubs_series/6144, all of which are hereby incorporated by reference in their entireties. In some examples, the polarization-sensitive eye/face tracking IR sensor 615 may include a polarization-sensitive NIR camera.

In some examples, the polarization-sensitive eye/face tracking may include, e.g., glint filtering which is performed utilizing the polarization state and intensity of the IR light received by the polarization-sensitive eye/face tracking IR sensor 615. In such examples, the 2nd Purkinje corneal glints may be identified and utilized in the eye/face tracking process, as the 2nd Purkinje corneal glints have a high intensity and a low degree of linear polarization.

As described above and discussed further below, the optical stack 610 in FIG. 6 may include any combination of active and/or passive components, including any type of optical, electro-optical, mechanical, electrical, electronic, etc., element, as would be understood by one of ordinary skill in the art. In some examples, the optical stack 610 may include one or more lenses, such as, e.g., the 1^{st} lens 611 and the 2^{nd} lens 612. In some examples, the optical stack 610 may include any one or more of the display optics 124 and/or display electronics 122 in FIG. 1, such as, e.g., the display screen 620.

Although the linearly-polarized eye/face tracking IR light sources 605a and 605b are shown as located between the 1^{st} lens 611 and the 2^{nd} lens 612 in FIG. 6, this is purely for illustrative purposes, and the one or more linearly-polarized eye/face tracking IR light sources according to the present disclosure may be disposed anywhere as long as the linearly-polarized IR light shines on, and is reflected from, the user's eye such that eye/face tracking may be performed using those IR reflections, as would be understood by one of ordinary skill in the art. Accordingly, for example, the one or more linearly-polarized eye/face tracking IR light sources according to the present disclosure may be embedded in one or more elements of the optical stack 610 (such as, e.g. the glass of the 1st lens 611 and/or the 2^{nd} lens 612), positioned in, on and/or behind the display screen 620, and/or placed in other positions/locations, as would be understood by one of ordinary skill in the art.

Similarly, although the polarization-sensitive eye/face tracking IR sensor 615 is shown as located outside the 2^{nd} lens 612 in FIG. 6, pointing towards the eye so to receive the IR reflections therefrom, this is purely for illustrative purposes, and the one or more polarization-sensitive eye/face tracking IR sensors according to the present disclosure may be disposed anywhere as long as the one or more polarization-sensitive eye/face tracking IR sensors receive the linearly-polarized R reflections reflected from the user's eye such that eye/face tracking may be performed using those IR reflections, as would be understood by one of ordinary skill in the art. Accordingly, for example, the one or more polarization-sensitive eye/face tracking IR sensors according to the present disclosure may be embedded within the optical stack 610 (such as, e.g., between the 1^{st}lens 611 and the 2^{nd} lens 612), positioned on, in, and/or behind the display screen 620, or placed in other positions/locations, as would be understood by one of ordinary skill in the art. In some examples, the one or more polarization-sensitive eye/face tracking IR sensors according to the present disclosure may be disposed so as to point to a reflective element rather than directly at the eye (such as, e.g., pointing at an IR reflective layer on, in, or behind the display screen 620).

As described and discussed above and further below, the linearly-polarized eye/face tracking IR light sources 605a and 605b in FIG. 6 may include any of the projectors and/or light sources as described herein, such as, e.g., LEDs, VCSELs, LCDs, PICs, etc., as well as any suitable linearly-polarized-capable IR light source, as would be understood by one of ordinary skill in the art. As mentioned above, the number, relative position(s), and relative location(s) of the integrated switchable linearly-polarized eye/face tracking IR light sources 605a and 605b shown in FIG. 6 are purely for purposes of explanation, and any number of switchable linearly-polarized eye/face tracking IR light sources may be positioned in any suitable location and any suitable disposition for illuminating the user's eye according to examples of the present disclosure, as also discussed further below.

In some examples, the linearly-polarized eye/face tracking IR light sources 605a and 605b in FIG. 6 may include a light source and a separate and/or integrated polarizing element to polarize the light of the light source, according to the present disclosure. For instance, a light source may be fitted with a polarizer, which may be an active component (i.e., electrically and/or electronically activated and/or controlled) or a passive component (e.g., such as a polarizer, a linearly-polarizing lens, a combination of optical components, etc., as would be understood by one of ordinary skill in the art). In some examples, the linearly-polarized eye/face tracking IR light sources 605a and 605b may be switchable components.

As described and discussed above and further below, the polarization-sensitive eye/face tracking IR sensor 615 in FIG. 6 may include any camera, imaging sensor, and/or any non-imaging sensor suitable for eye/face tracking, as described herein and/or as would be known to one of ordinary skill in the art. As discussed herein, the number, relative position(s), and relative location(s) of the polarization-sensitive eye/face tracking IR sensor 615 shown in FIG. 6 is purely for purposes of explanation, and any number of polarization-sensitive eye/face tracking IR sensors may be positioned in any suitable location and any suitable disposition for receiving IR reflections from the user's eye according to examples of the present disclosure, as also discussed further below.

In some examples, the one or more polarization-sensitive eye/face tracking IR sensors according to the present disclosure may include one or more IR sensors and one or more separate and/or integrated polarization elements to implement a combination of components which is effectively polarization-sensitive. In some examples, the one or more polarization-sensitive eye/face tracking IR sensors according to the present disclosure may be fitted with one or more polarization-sensitive elements, which may be one or more active components (i.e., electrically and/or electronically activated and/or controlled) and/or one or more passive components (e.g., such as a polarizer, a linearly-polarizing lens, a combination of optical components, etc., as would be understood by one of ordinary skill in the art). In some examples, the one or more eye/face tracking IR sensors according to the present disclosure may be communicatively connected to one or more controllers (such as, e.g., the controller 630) which may perform signal processing such that the one or more eye/face tracking IR sensors are made effectively polarization-sensitive by processing the signals received from the one or more eye/face tracking IR sensors (without, for example, any polarization-sensitive hardware), as would be understood by one of ordinary skill in the art.

As described above and discussed further below, the display screen 620 in FIG. 6 may include any combination of active and/or passive components, including any type of optical, electro-optical, mechanical, electrical, electronic, etc., element, as would be understood by one of ordinary skill in the art. In some examples, the display screen 620 may be integrated into the optical stack 610. In some examples, there may be no display screen at all—i.e., in a near-eye device which uses an eye/face tracking system but does not use an imaging system. Moreover, examples of the configuration 600 according to examples of the present disclosure may be implemented in any type of near-eye device, including, but not limited to, the near-eye display device 120 in FIG. 1, the HMD device 200 in FIGS. 2A-2C, the near-eye device 300 in FIG. 3, the near-eye devices 400A and 400B in FIGS. 4A and 4B, a near-eye device using the waveguide-based configuration 4000 in FIG. 4C, etc.

As discussed in detail further below, the controller 630 may control and/or be communicatively connected to any one or more of the linearly-polarized eye/face tracking IR light sources 605a and 605b, one or more constituent components within the optical stack 610, the polarization-sensitive eye/face tracking IR sensor 615, the display screen 620, and/or any other components not shown in FIG. 6. Optional control and/or communication connections to the controller 630 are indicated by dotted lines in this and the drawings described below. In some examples, the controller 630 may perform one, more, and/or all of the eye/face tracking operations for the configuration 600. In some examples, the controller 630 may be one or more of the eye/face tracking unit 130 and/or eye/face tracking module 118 in FIG. 1 as described above, and/or any other processing or controlling module which may be used for eye/face tracking operations in a near-eye device, as would be understood by one of ordinary skill in the art. In some examples, the controller 630 may include a processor 633 and a memory 635 (and/or be communicatively connected to one or more memories), where the memory may be a non-transitory computer-readable storage media which may store instructions that, when executed by the processor 633, may cause the processor 633 to perform any of the functions described herein and/or to control any of the components described herein, as described and discussed more fully further below.

FIG. 7 is a block diagram of a configuration 700 of one or more linearly-polarized eye/face tracking IR light sources for illuminating an eye and an eye/face tracking grayscale camera fitted with a linear polarization filter for receiving reflections of the linearly-polarized IR light from the eye, according to an example of the present disclosure. More specifically, configuration 700 may include linearly-polarized eye/face tracking IR light sources 705a and 705b integrated into an optical stack 710 (which may, in turn, include a 1^{st} lens 711 and a 2^{nd} lens 712), an eye/face tracking grayscale IR camera 715, a display screen 720, and a controller 730 (which may, in turn, include processor 733 and/or memory 735).

In form and function, the linearly-polarized eye/face tracking IR light sources 705a and 705b, the optical stack 710 (including, e.g., the 1^{st} lens 711 and the 2^{nd} lens 712), the display screen 720, and the controller 730 in FIG. 7 may be substantially similar to the linearly-polarized eye/face tracking IR light sources 605a and 605b, the optical stack 610 (including, e.g., the 1^{st} lens 611 and the 2^{nd} lens 612), the display screen 620, and the controller 630, respectively, in FIG. 6, as described above and discussed further below.

Accordingly, the configuration 700 shown in FIG. 7 is similar to the configuration 600 in FIG. 6, except that the eye/face tracking IR sensor in FIG. 7 is a grayscale IR camera 715 fitted with a linear polarization filter 716. In some examples, the grayscale IR camera 715 may include an array of light sensors/pixels without color filters. In some examples, the polarization state of the linear polarization filter 716 may be orthogonal to the polarization state of one or more known stray light sources, such as, e.g., the reflections from the surfaces of components in the optical stack such as the inner surfaces of, e.g., the 1^{st} lens 711 and the 2^{nd} lens 712. Accordingly, the primary specular glints and stray light may be suppressed, preserving the dynamic range of the grayscale IR camera 715. Moreover, the 2nd Purkinje corneal glints/reflections may remain at a relatively high intensity, because they are mostly de-polarized through interactions with the birefringent cornea of the eye.

In some examples, the linear polarization filter 716 may be one or more active and/or passive components, as would be understood by one of ordinary skill in the art, such as, e.g., one or more electrically and/or electronically activated/controlled components and/or one or more polarizers, linearly-polarizing lenses, birefringent elements, etc. In some examples, the linear polarization filter 716 may not be physically and/or otherwise attached to the grayscale IR camera 715, but may rather be placed anywhere in the light path of the IR reflections from the eye to the grayscale IR camera 715.

FIG. 8 is a block diagram illustrating a configuration 800 of one or more linearly-polarized eye/face tracking IR light sources for illuminating an eye and a polarization-sensitive eye/face tracking IR sensor for receiving reflections of the linearly-polarized light from the eye, according to an example of the present disclosure, where the optical stack may contain one or more optical retarders. More specifically, the configuration 800 may include linearly-polarized eye/face tracking IR light sources 805a and 805b integrated into an optical stack 810 (which may, in turn, include a 1^{st} lens 811 and a 2^{nd} lens 812), one or more optical retarders 807 in the optical stack 810, a polarization-sensitive eye/face tracking IR sensor 815 with an optical counter-retarder 817, a display screen 820, and a controller 830 (which may, in turn, include processor 833 and/or memory 835).

In form and function, the linearly-polarized eye/face tracking IR light sources 805a and 805b, the optical stack 810 (including, e.g., the 1^{st} lens 811 and the 2^{nd} lens 812), the polarization-sensitive eye/face tracking IR sensor 815, the display screen 820, and the controller 830 in FIG. 8 may be substantially similar to the linearly-polarized eye/face tracking IR light sources 605a and 605b, the optical stack 610 (including, e.g., the 1st lens 611 and the 2^{nd} lens 612), the polarization-sensitive eye/face tracking IR sensor 615, the display screen 620, and the controller 630, respectively, in FIG. 6, as described above and discussed further below.

Accordingly, the configuration 800 shown in FIG. 8 is similar to the configuration 600 in FIG. 6, except that the optical stack 810 includes one or more optical retarders 807 (such as, e.g., a half and/or quarter waveplate). In order to counter-balance the effects of the one or more optical retarders 807 in the optical stack 810, the eye/face tracking IR sensor 815 in FIG. 8 is fitted with an optical counter-retarder 817. In some examples, the optical counter-retarder 817 provides the opposite amount of retardance in S- and P-polarized light to counterbalance the polarization effects of the one or more optical retarders 807 in the optical stack 810. In some examples, the optical counter-retarder 817 may not be physically and/or otherwise attached to the eye/face tracking IR sensor 815, but may rather be disposed in any position/location to effectively counterbalance the polarization effects of the one or more optical retarders 807 on the IR reflections from the eye to the eye/face tracking IR sensor 815. In some examples, the optical counter-retarder 817 may include one or more active and/or passive components, as would be understood by one of ordinary skill in the art.

Although the one or more optical retarders 807 are shown as located between the 1^{st} lens 811 and the 2^{nd} lens 812 in FIG. 8, this is purely for illustrative purposes, and the same principles would apply according to the present disclosure wherever the one or more optical retarders 807 may be disposed, and for whatever reason, as would be understood by one of ordinary skill in the art. Accordingly, as long as the one or more components comprising the optical counter-retarder 817 provide the opposite amount of retardance in S- and P-polarized light to counterbalance the polarization effects of the one or more optical retarders 807, the number, location, disposition, direction, polarization, etc., of the one or more optical retarders 807 may vary in any of the different implementations according to the present disclosure, as would be understood by one of ordinary skill in the art. In some examples, one, some, and/or all the one or more optical retarders 807 may include one or more active and/or passive components, as would be understood by one of ordinary skill in the art.

FIG. 9 is a block diagram illustrating a configuration 900 of one or more linearly-polarized eye/face tracking IR light sources for illuminating an eye and a polarization-sensitive eye/face tracking IR sensor, which is fitted with an active polarization rotator for receiving reflections of the linearly-polarized light from the eye, according to an example of the present disclosure. More specifically, the configuration 900 may include linearly-polarized eye/face tracking IR light sources 905a and 905b integrated into an optical stack 910 (which may, in turn, include a 1^{st} lens 911 and a 2^{nd} lens 912), a polarization-sensitive eye/face tracking IR sensor 915, a display screen 920, and a controller 930 (which may, in turn, include processor 933 and/or memory 935).

In form and function, the linearly-polarized eye/face tracking IR light sources 905a and 905b, the optical stack 910 (including, e.g., the 1^{st} lens 911 and the 2^{nd} lens 912), the display screen 920, and the controller 930 in FIG. 9 may be substantially similar to the linearly-polarized eye/face tracking IR light sources 605a and 605b, the optical stack 610 (including, e.g., the 1^{st} lens 611 and the 2^{nd} lens 612), the display screen 620, and the controller 630, respectively, in FIG. 6, as described above and discussed further below.

Thus, the configuration 900 shown in FIG. 9 is similar to the configuration 600 in FIG. 6, except that the polarization-sensitive eye/face tracking IR sensor in FIG. 9 is an IR sensor 915 fitted with an active polarization rotator 919 which is switchable between filtering for S-polarization and filtering for P-polarization. In some examples, the active polarization rotator 919 may be combined with a linear filter. In some examples, the active polarization rotator 919 may rapidly switch between S-polarization and P-polarization filtering in each successive frame/image/sensing of the eye/face tracking IR sensor 915. Accordingly, the configuration 900 with the active polarization rotator 919 in FIG. 9 may further increase the overall sensitivity of the eye/face tracking system to the degree of linear polarization for, e.g., light filtering purposes.

In some examples, the active polarization rotator 919 may not be physically and/or otherwise attached to the IR sensor 915, but may rather be placed anywhere in the light path of the IR reflections from the eye to the IR sensor 915. In some examples, the active polarization rotator 919 may include one or more active and/or passive components, as would be understood by one of ordinary skill in the art. In some examples, the eye/face tracking IR sensor 915 may include any number of active and/or passive components (in any suitable combination), including any type of optical, electro-optical, mechanical, electrical, electronic, etc., element, as would be understood by one of ordinary skill in the art. In some examples, the linearly-polarized eye/face tracking IR light sources 905a and 905b may also be switchable between polarization states such as, e.g., between S-polarization and P-polarization.

FIG. 10A is a block diagram illustrating a configuration 1000A of one or more pulsed time of flight (ToF) eye/face tracking IR light sources for illuminating an eye and a ToF eye/face tracking IR sensor for receiving reflections of the pulsed IR light from the eye, according to an example of the present disclosure; whereas FIG. 10B is a graphic 1000B showing the amount of photons detected by a configuration such as the configuration 1000A in FIG. 10A over time, indicating the time-gated period suitable for isolating IR reflections from the eye, according to an example of the present disclosure.

Time of Flight (ToF) refers to measurements made by transmitting a light signal towards a target, and then receiving returning light reflected and/or scattered back from the target. In direct Time of Flight (dToF) implementations, the time between the transmission of the light signal and the sensing of the reflected/backscattered light signal may be measured to determine the distance to the target. In indirect Time of Flight (iToF) implementations, the phase-shift of the reflected/backscattered light signal may be used to determine the distance to the target. In some examples, the velocity may also be measured using multiple ToF measurements over time; in other examples, other measurements may be made using ToF signals. Eye/face tracking according to examples of the present disclosure may be implemented as either, or both, dToF and/or iToF, regardless of how particular examples may be described herein.

Further description and discussion of implementations of ToF and/or eye/face tracking using ToF may be found in, for example, U.S. patent application Ser. No. 18/359,585, entitled INDIRECT TIME OF FLIGHT (TOF) DEPTH SENSING FOR EYE TRACKING, published on Apr. 18, 2024 as U.S. Pat. Pub. No. 2024/0126367 and assigned to the same assignee as the present disclosure; U.S. patent application Ser. No. 17/748,777, entitled ADDRESSABLE PROJECTOR FOR DOT BASED DIRECT TIME OF FLIGHT DEPTH SENSING, published on Sep. 7, 2023 as U.S. Pat. Pub. No. 2023/0280468 and also assigned to the same assignee as the present disclosure; and U.S. patent application Ser. No. 18/391,655, entitled STACKED TIME-OF-FLIGHT MODULE, published on Jul. 18, 2024 as U.S. Pat. Pub. No. 2024/0241231 and also assigned to the same assignee as the present disclosure, all of which are hereby incorporated by reference herein in their entireties (hereinafter referred to collectively as “the ToF references”).

In FIG. 10A, the configuration 1000A may include pulsed/ToF eye/face tracking IR light sources 1003x and 1003y integrated into an optical stack 1010 (which may, in turn, include a 1^{st} lens 1011 and a 2^{nd} lens 1012), a ToF eye/face tracking IR sensor 1015A, a display screen 1020, and a controller 1030 (which may, in turn, include processor 1033 and/or memory 1035). In form and function, the optical stack 1010 (including, e.g., the 1^{st} lens 1011 and the 2^{nd} lens 1012) and the display screen 1020 in FIG. 10A may be substantially similar to the optical stack 610 (including, e.g., the 1^{st} lens 611 and the 2^{nd} lens 612) and the display screen 620, respectively, in FIG. 6, as described and discussed herein. Insofar as they may perform the same functions, the pulsed/ToF eye/face tracking IR light sources 1003x and 1003y, the ToF eye/face tracking IR sensor 1015A, and the controller 1030 in FIG. 10A may be substantially similar to the linearly-polarized eye/face tracking IR light sources 605a and 605b, the polarization-sensitive eye/face tracking IR sensor 615, and the controller 630, respectively, in FIG. 6, as described and discussed herein. Insofar as they may perform one or more ToF functions, the pulsed/ToF eye/face tracking IR light sources 1003x and 1003y, the ToF eye/face tracking IR sensor 1015A, and the controller 1030 in FIG. 10A may be suitably modified/implemented to perform such ToF functions, as would be understood to one of ordinary skill in the art. See, e.g., the ToF references.

Configuration 1000A of FIG. 10A represents an approach where a ToF sensor and pulsed ToF IR light sources may be utilized for eye/face tracking using time-gated detection. In some examples, time-gating alone may be utilized for eye/face tracking; in other examples, a combination of time-gating and polarization management (such as, e.g., shown in FIGS. 6-9) may be utilized for eye/face tracking. Time-gating-only solutions may allow a small amount of the stray light because of the delay accumulated through multiple IR reflections; whereas time-gating-and-polarization-management combination solutions may mitigate such passed-through stray light.

As mentioned above, the configuration 1000A of FIG. 10A in some examples may utilize any of the polarization configurations of FIGS. 6-9. Accordingly, in some examples, the pulsed/ToF eye/face tracking IR light sources 1003x and 1003y may be linearly polarized (as indicated in brackets in FIG. 10A) and the polarization-sensitive ToF eye/face tracking IR sensor 1015A in configuration 1000A of FIG. 10A may include a ToF eye/face tracking IR sensor 1016A fitted with a polarization element 1017A (such as, e.g., the linear polarization filter 716 of FIG. 7 and/or the active polarization rotator 919 of FIG. 9).

In some examples, the polarization element 1017A may include any number of active and/or passive components (in any suitable combination), including any type of optical, electro-optical, mechanical, electrical, electronic, etc., element, as would be understood by one of ordinary skill in the art. In some examples, the polarization element 1017A may not be physically and/or otherwise attached to the ToF IR sensor 1016A, but may rather be placed anywhere in the light path of the IR reflections from the eye to the ToF IR sensor 1016A. In other examples, the ToF IR sensor 1016A may itself be polarization-sensitive (by, e.g., using integrated components). In some examples, the ToF IR sensor 1016A may be communicatively connected to one or more controllers (such as, e.g., the controller 1030) which may perform signal processing such that the ToF IR sensor 1016A is made effectively polarization-sensitive by processing the signals received from the ToF IR sensor 1016A (without, for example, any polarization-sensitive hardware), as would be understood by one of ordinary skill in the art. In some examples, the ToF eye/face tracking IR sensor 1016A may include any number of active and/or passive components (in any suitable combination), including any type of optical, electro-optical, mechanical, electrical, electronic, etc., element, as would be understood by one of ordinary skill in the art.

The graphic 1000B in FIG. 10B, as mentioned above, shows the number of photons detected by a configuration such as the configuration 1000A in FIG. 10A over time, according to an example of the present disclosure. As shown in FIG. 101B, there are periods of time which may be suitable for isolating ToF IR reflections from the eye; more specifically, a time period 1050B is indicated between two parallel vertical lines in the graphic 1000B in FIG. 10B, where a peak of ToF IR reflections from the eye may be seen, as would be understood by one of ordinary skill in the art.

As discussed and described herein, the one or more eye/face tracking IR light sources 605a/605b, 705a/705b, 805a/805b, 905a/905b, and/or 1003x/1003y in any of FIGS. 6, 7, 8, 9, and/or 10A may be any number and/or combination of active/passive components, in any suitable location and/or disposition, as would be understood by one of ordinary skill in the art, including, but not limited to, any type of LCD, LED (including, e.g., mLEDs, OLEDs, ILEDs, AMOLEDs, TLEDs, SLEDs, edge emitting LEDs, etc.), laser (such as, VCSELs), photonic integrated circuit (PIC) based illuminator, any of the various eye/face tracking projectors/light sources discussed and/or referred to herein, and/or any other suitable light source. In an example utilizing one or more VCSELs, the VCSEL(s) may include one or more of a wide variety of possible VCSEL architectures and/or fabrications, and may include, for example, tunnel junction VCSELs, wafer-bonded and/or wafer-fused VCSELs, VECSELs, VCSELs with multiple active regions, tunable VCSELs (which may employ, e.g., MEMS), VCSOAs, two or more VCSELs disposed for optical pumping (e.g., monolithically optically pumped VCSELs), etc. Any other suitable light source construction, architecture, and/or fabrication may be employed, as would be understood by one of ordinary skill in the art in light of the examples of the present disclosure, using, for example—with appropriate architectural modifications, an EEL, a HC-SEL, a QDL, a QCL, etc.

As discussed and described herein, the one or more eye/face tracking IR sensors 615, 715, 815, 915, and/or 1015A (and/or 1016A) in any of FIGS. 6, 7, 8, 9, and/or 10A may be any number and/or combination of active/passive components, in any suitable location and/or disposition, as would be understood by one of ordinary skill in the art. Accordingly, an eye/face tracking IR sensor according to the present disclosure may include any one or more of a camera, an imaging sensor, and/or a non-imaging sensor suitable for eye/face tracking, as would be understood by one of ordinary skill in the art.

In some examples, one or more eye/face tracking IR light sources and one or more eye/face tracking IR sensors may be combined according to the present disclosure to perform as an integrated eye/face tracking light source/sensor, such as a combined VCSEL/SMI integrated circuit which may be disposed, e.g., within the optical stack itself (as part of a microscopic array, for example).

As discussed and described herein, the optical stacks 610, 710, 810, 910, and/or 1010 in any of FIGS. 6, 7, 8, 9, and/or 10A may be any number and/or combination of active/passive components, in any suitable construction, location and/or disposition, as would be understood by one of ordinary skill in the art, and may include, for example, the display optics 124 and/or display electronics 122 in FIG. 1 (including, e.g., any of the display screens 610, 710, 810, 910, and/or 101 in FIGS. 6, 7, 8, 9, and/or 10A), any type of beam-forming/beam-shaping element (including, e.g., a lens or an aperture), any type of refractive element (including, e.g., a lens or an aperture), any type of reflective element (such as, e.g. a mirror), any type of diffractive element, any type of polarization element, any type of coating (including, e.g., an optical coating), any type of nano-optics (including, e.g., metalenses and metasurfaces), any type of micro-structures (including those fabricated using 3D printing), and/or any other suitable technology, layer, coating, and/or material feasible and/or possible either presently or in the future, as would be understood by one of ordinary skill in the art. In some examples, the optical stack and/or the display screen according to the present disclosure may utilize optics/electronics suitable for any of AR, VR, and/or MR display, such as, for example, folded optics and/or pancake optics, as would be understood by one of ordinary skill in the art. See, e.g., Meta's 784 patent, Meta's 622 patent, and/or Meta's ′239 patent.

As discussed and described herein, the display screen 610, 710, 810, 910, and/or 1010 in any of FIGS. 6, 7, 8, 9, and/or 10A may be any number and/or combination of active/passive components, in any suitable location and/or disposition, for providing one or more images to the user's eye(s), as would be understood by one of ordinary skill in the art. In some examples, there may be no separate and/or operable display screen, because, e.g., either the one or more images are projected onto the user's eye(s) or the near-eye device does not project any images to the user at all, but rather merely performs eye/face tracking.

As discussed and described herein, the one or more controllers 630, 730, 830, 930, and/or 1030 in any of FIGS. 6, 7, 8, 9, and/or 10A may include any number and/or combination of active/passive components, in any suitable location and/or disposition, in order to perform one or more functions of eye/face tracking, as would be understood by one of ordinary skill in the art. In some examples, the one or more controllers 630, 730, 830, 930, and/or 1030 in any of FIGS. 6, 7, 8, 9, and/or 10A may control and/or be communicatively connected to any one or more of the eye/face tracking IR light sources 605a/605b, 705a/705b, 805a/805b, 905a/905b, and/or 1003x/1003y; one or more constituent components within the optical stack 610, 710, 810, and/or 1010; the one or more eye/face tracking IR sensors 615, 715, 815, 915, and/or 1015A (and/or 1016A); the display screen 610, 710, 810, 910, and/or 1010; and/or any other components not shown in any FIGS. 6, 7, 8, 9 and/or 10A, respectively.

As discussed and described herein, the one or more controllers 630, 730, 830, 930, and/or 1030 in any of FIGS. 6, 7, 8, 9, and/or 10A may include one or more processors 633, 733, 833, 933, and/or 1033 and/or one or more memories 635, 735, 835, 935, and/or 1035. In some examples, a non-transitory computer-readable storage medium (such as, e.g., memories 635, 735, 835, 935, and/or 1035) may store instructions executable by the one or more controllers 630, 730, 830, 930, and/or 1030 in any of FIGS. 6, 7, 8, 9, and/or 10A (and/or any of the one or more processors 633, 733, 833, 933, and/or 1033). The non-transitory computer-readable storage medium may be any type of suitable memory, such as a hard disk drive, a removable memory, or a solid-state drive (e.g., flash memory or dynamic random access memory (DRAM)), as would be understood by one of ordinary skill in the art.

### C. Methods for Stray Light Reduction in an Eye/Face Tracking System of a Near-Eye Device

FIG. 11 is a flow diagram illustrating a method 1100 of polarization-sensitive pre-processing for an eye/face tracking system in a near-eye device to mitigate stray light, according to examples of the present disclosure. The method 1100 is provided by way of example, as there may be a variety of ways to carry out the method described herein, and may be one part of an entire process, procedure, ongoing operation, method, etc., as would be understood by one of ordinary skill in the art. The method 1100 may further omit parts of any process, procedure, ongoing operation, method, etc., not germane to examples of the present disclosure, as would be understood by one of ordinary skill in the art, and each block shown in FIG. 11 may further represent one or more steps, processes, methods, or subroutines, as would be further understood by one of ordinary skill in the art. For the sake of convenience and ease of explanation, the blocks in FIG. 11 may refer to the components shown in the FIGS. described herein; however, the method 1100 is not limited in any way to the components, apparatuses, and/or constructions described and/or shown in any of the FIGS. herein.

Some of the processes indicated by the blocks in FIG. 11 may overlap, occur substantially simultaneously, and/or be continually repeated, and, moreover, the blocks may be performed by different processing components. For example, block 1105 in FIG. 11 may be performed by any of the one or more eye/face tracking IR sensors 615, 715, 815, 915, and/or 1015A (and/or 1016A) in any of FIGS. 6, 7, 8, 9, and/or 10A, respectively, while any one or more of the remaining blocks 1110-1150 in FIG. 11 may be performed, in whole or part, by any of the one or more controllers 630, 730, 830, 930, and/or 1030 in any of FIGS. 6, 7, 8, 9, and/or 10A, respectively. Similarly, block 1105 (and some or all of the following blocks) in FIG. 11 may be performed by any of the eye/face tracking camera(s) 406, 426, and/or 436 in FIGS. 4A, 4B, and/or 4C, respectively, while any one or more of the remaining blocks 1110-1150 in FIG. 11 may be performed, in whole or part, by any of the one or more controllers 430A, 430B, and/or 430C in FIGS. 4A, 4B, and/or 4C, respectively. Similarly, any of the blocks in FIG. 11 may be performed, in whole or part, by any of the eye/face tracking unit 130 and/or eye/face tracking module 118 in FIG. 1, any other sensing and/or processing component described in Sect. I, and/or any other suitable sensing and/or processing component, as would be understood by one of ordinary skill in the art.

At block 1105, a polarization-sensitive image may be captured. In some examples, the captured polarization sensitive image may be a linearly polarized illumination with a Stokes camera or similar.

At block 1110, measurements may be computed using the captured polarization-sensitive image: namely, (i) the intensity; (ii) the angle of linear polarization (AOLP); and (iii) the degree of linear polarization (DOLP) may be computed. In some examples, these measurements may be employed to identify and/or mitigate the stray light in the captured polarization sensitive image.

At blocks 1123-1125-1127, various types of light within the captured polarization-sensitive image may be identified. More specifically, stray light glints may be identified utilizing the AOLP and DOLP computed at block 1110 at block 1123; primary glints may be identified at block 1125; and light backscattered from the eye and periocular tissues may be identified at block 1127. In some examples (such as, e.g., the example shown in FIG. 12), the stray light identified at block 1123 may be further removed from the captured image. In some examples, the backscattered light may be identified at block 1127 by detecting areas of low DOLP within the captured image, detecting areas of noisy AOLP within the captured image, detecting areas of low-to-medium intensity within the captured image, a combination thereof, etc., as would be understood by one of ordinary skill in the art.

At block 1130, image segmentation may be applied to the captured polarization-sensitive image. In some examples, the polarization and/or spatial properties of the light may be considered to segment the image (e.g., glints from the eye may be circular, stray light may be circular or streaked, etc., as would be understood by one of ordinary skill in the art). Accordingly, the method 1100 may segment the captured polarization-sensitive image into different clusters of pixels that have similar properties and/or spatial correlation (and thus the received light in a segment/cluster of pixels may likely have the same origin-such as, e.g., glints reflected from the eye vs. stray light, etc.).

At block 1140, a probability map may be computed using the polarization data and/or segmentation from block 1130, where the resulting probability map indicates the probability of the origin of the light in any pixel and/or group of pixels in the captured polarization-sensitive image. In some examples, the probability map of block 1140 may indicate the probability of the light in any pixel and/or group of pixels is from, e.g., eye glints (i.e., reflections from the eye/face tracking structured IR light) or from stray light. In some examples, the image segments from block 1130 may be used to group the pixels in the probability map of block 1140.

At block 1150, eye/face tracking pre-processing may be performed using the probability map of block 1140. In some examples, the method 1100 at block 1150 uses the probability map from block 1140 to pre-process the captured polarization-sensitive image for further analysis with eye/face tracking algorithms. In some examples, the eye/face tracking pre-processing in block 1150 may include the mitigation of the effects of stray light on the performance of the eye/face tracking algorithms. In some examples, the eye/face tracking pre-processing in block 1150 may include the identification of the reflections from the eye/face tracking structured IR light from the eye (e.g., the corneal glints), thereby improving on the performance of the eye/face tracking algorithms. In some examples, the eye/face tracking pre-processing in block 1150 may include calculating separate images that minimize contributions from stray light and/or identifies and perhaps enhances contributions from corneal glints.

FIG. 12 is a flow diagram illustrating a method 1200 of stray light reduction for an eye/face tracking system in a near-eye device, according to examples of the present disclosure. The method 1200 is provided by way of example, as there may be a variety of ways to carry out the method described herein, and may be one part of an entire process, procedure, ongoing operation, method, etc., as would be understood by one of ordinary skill in the art. The method 1200 may further omit parts of any process, procedure, ongoing operation, method, etc., not germane to examples of the present disclosure, as would be understood by one of ordinary skill in the art, and each block shown in FIG. 12 may further represent one or more steps, processes, methods, or subroutines, as would be further understood by one of ordinary skill in the art. For the sake of convenience and ease of explanation, the blocks in FIG. 12 may refer to the components shown in the FIGS. described herein; however, the method 1200 is not limited in anyway to the components, apparatuses, and/or constructions described and/or shown in any of the FIGS. herein. Some of the processes indicated by the blocks in FIG. 12 may overlap, occur substantially simultaneously, and/or be continually repeated, and, moreover, the blocks may be performed by different processing components.

At block 1210, an eye/face tracking IR light source projects linearly-polarized IR light onto the eye of a user of a near-eye device. In some examples, the eye/face tracking IR light source may project, directly and/or indirectly, unstructured and/or structured light suitable for performing eye/face tracking, as would be understood by one of ordinary skill in the art. In some examples, the projected structured light may include, e.g., one or more images and/or one or more patterns (such as, e.g., a fringe pattern). In some examples, the eye/face tracking IR light source in block 1210 may include multiple eye/face tracking projectors or may be integrated into a light projection source used for other purposes, such as MR, AR, and/or VR content projection. In some examples, the eye/face tracking IR light source in block 1210 may include any number and/or combination of active/passive components, in any suitable location and/or disposition, as would be understood by one of ordinary skill in the art, including, but not limited to, any type of IR light source and any type of polarization element to linearly-polarize the IR light (which may, or may not, be integrated into the IR light source itself). In some examples, the eye/face tracking IR light source in block 1210 may include any one or more of the linearly-polarized IR light sources 605a/605b, 705a/705b, 805a/805b, 905a/905b, and/or 1003x/1003y of FIGS. 6, 7, 8, 9, and 10A, respectively, and/or any one or more of the IR projectors 405 in FIGS. 4A-4C.

At block 1215, reflections of IR light from the user's eye are sensed and/or received. In some examples, the reflections of IR light are received by a camera and/or one or more imaging sensors; in other examples, the reflections of IR light are sensed/received by one or more non-imaging sensors. In some examples, the camera(s), imaging sensor(s), and/or non-imaging sensor(s) may be dedicated apparatuses in the eye/face tracking system of the near-eye device; in other examples, the camera(s), imaging sensor(s), and/or non-imaging sensor(s) may be multi-tasking apparatuses used by multiple systems in the near-eye device, including the eye/face tracking system. In some examples, block 1215 in FIG. 12 may be performed by any of the one or more eye/face tracking IR sensors 615, 715, 815, 915, and/or 1015A (and/or 1016A) in any of FIGS. 6, 7, 8, 9, and/or 10A, respectively; any of the eye/face tracking camera(s) 406, 426, and/or 436 in FIGS. 4A, 4B, and/or 4C, respectively; the eye/face tracking unit 130 and/or eye/face tracking module 118 in FIG. 1; any other sensing component described in Sect. I; and/or any other suitable sensing component, as would be understood by one of ordinary skill in the art.

At block 1220, a 2D image is formed from the sensed/received reflections of block 1215. Similarly to block 1215, the one or more devices performing block 1220 may be dedicated apparatuses in the eye/face tracking system of the near-eye device in some examples; in other examples, the one or more devices performing block 1220 may be multi-tasking apparatuses used by multiple systems in the near-eye device, including the eye/face tracking system. In some examples, blocks 1215 and 1220 may effectively be performed using one or more cameras and/or imaging sensors in a single process/block of capturing the 2D image. In some examples, block 1220 in FIG. 12 may be performed by any of the one or more eye/face tracking IR sensors 615, 715, 815, 915, and/or 1015A (and/or 1016A) in any of FIGS. 6, 7, 8, 9, and/or 10A, respectively; any of the eye/face tracking camera(s) 406, 426, and/or 436 in FIGS. 4A, 4B, and/or 4C, respectively; the eye/face tracking unit 130 and/or eye/face tracking module 118 in FIG. 1; any other imaging/processing component described in Sect. I; and/or any other suitable imaging/processing component, as would be understood by one of ordinary skill in the art. In some examples, block 1220 in FIG. 12 may be performed, in whole or part, by any one or more of the controllers 630, 730, 830, 930, and/or 1030 in any of FIGS. 6, 7, 8, 9, and/or 10A, respectively; any one or more of the controllers 430A, 430B, and/or 430C in FIGS. 4A, 4B, and/or 4C, respectively; the eye/face tracking unit 130 and/or eye/face tracking module 118 in FIG. 1; any other imaging/processing component described in Sect. I; and/or any other suitable imaging/processing component, as would be understood by one of ordinary skill in the art.

At block 1230, metrics are computed for one or more pixels in the 2D image, including, but not necessarily limited to, one or more polarization metrics (such as, e.g., AOLP, DOLP, etc.). In some examples, non-polarization metrics, such as, e.g., intensity, may be computed in block 1230.

At block 1240, the 2D image is segmented using at least the polarization metrics computed in block 1230. In some examples, segments are identified, isolated, and/or separated by having groups of one or more pixels with the same one or more polarization metrics, one or more pixels with substantially the same one or more polarization metrics, and/or one or more pixels having one or more polarization metrics in the same range of values. In some examples, segments are identified, isolated, and/or separated by having groups of one or more pixels with the same set of metrics (including one or more polarization metrics), one or more pixels with substantially the same values for the one or more metrics in the same set of metrics (including one or more polarization metrics), and/or one or more pixels having one or more metrics within the same range of values in the same set of metrics (including one or more polarization metrics).

At block 1250, a light origin probability map is computed using the segmented 2D image from block 1240. In some examples, the light origin probability map may indicate the probability of the origin of the light in multiple 2D regions (each 2D region including multiple pixels) in the 2D image. In some examples, the light origin probability map may indicate the probability that some or all of the light in any particular 2D region is from stray light. In some examples, the light origin probability map may indicate the probability that some or all of the light in any particular 2D region is from corneal eye glints (i.e., reflections of the linearly-polarized IR light of block 1210). In some examples, the 2D regions of the light origin probability map in block 1250 may be substantially identical to the segments of the segmented 2D image of block 1240. In some examples, the 2D regions of the light origin probability map in block 1250 may not be substantially identical to the segments of the segmented 2D image of block 1240, but instead be merely calculated using the segments of the segmented 2D image of block 1240.

At block 1260, stray light and/or the effects of stray light may be mitigated, reduced, and/or eliminated using the light origin probability map computed in block 1250. In some examples, any 2D region(s) with a light origin probability substantially the same as a specific value or within a range of values indicating the likelihood of stray light may be eliminated and/or reduced when eye/face tracking is performed upon the 2D image. In some examples, any 2D region(s) with a light origin probability substantially the same as a specific value or within a range of values indicating the likelihood of corneal eye glints (i.e., reflections of the linearly-polarized IR light of block 1210) may be enhanced for eye/face tracking and/or identified/isolated for performing eye/face tracking excluding the other regions of the 2D image.

In FIG. 12, the one or more devices performing any one or more of blocks 1230-1260 may be dedicated apparatuses in the eye/face tracking system of the near-eye device in some examples; in other examples, the one or more devices performing any one or more of blocks 1230-1260 may be multi-tasking apparatuses used by multiple systems in the near-eye device, including the eye/face tracking system. In some examples, any one or more of blocks 1230-1260 in FIG. 12 may be performed by any of the eye/face tracking camera(s) 406, 426, and/or 436 in FIGS. 4A, 4B, and/or 4C, respectively; any other one or more imaging/processing components described in Sect. I; and/or any other suitable one or more imaging/processing components, as would be understood by one of ordinary skill in the art. In some examples, any one or more of blocks 1230-1260 in FIG. 12 may be performed, in whole or part, by any one or more of the controllers 630, 730, 830, 930, and/or 1030 in any of FIGS. 6, 7, 8, 9, and/or 10A, respectively; any one or more of the controllers 430A, 430B, and/or 430C in FIGS. 4A, 4B, and/or 4C, respectively; the eye/face tracking unit 130 and/or eye/face tracking module 118 in FIG. 1; any other one or more processing components described in Sect. I; and/or any other suitable one or more processing components, as would be understood by one of ordinary skill in the art.

FIG. 13 is a schematic block diagram illustrating a configuration 1300 for polarization-sensitive stray light reduction for an eye/face tracking system in a near-eye device, according to various examples. FIG. 13 is a schematic block diagram provided to illustrate a general explanation of various examples of the present disclosure, and may omit aspects, features, and/or components not germane to a general explanation of various examples of the present disclosure, as would be understood by one of ordinary skill in the art. As an example, neither the optics nor the other electronics for a near-eye device are shown in FIG. 13. Because FIG. 13 is a schematic block diagram, the components shown in FIG. 13 are for explanatory purposes, and are not intended to represent the accurate sizes, ratio of sizes (e.g., relative sizes), locations, dispositions, relative locations, relative dispositions, and/or relative dimensions of those components and/or structures in any specific implementations and/or examples according to the present disclosure. As an example, the relative sizes, locations, and/or dispositions of the one or more light sources, one or more light sensors, and/or one or more controller(s)/processor(s) shown in FIG. 13 may in no way approximate the relative sizes, relative locations, and/or relative dimensions of those components, but instead generally illustrate the illumination, the reception of reflections from the eye (including reflections of the illumination), and the processing of information/data obtained from the reception of the reflections from the eye for stray light reduction in eye/face tracking systems according to examples of the present disclosure, as would be understood by one of ordinary skill in the art.

FIG. 13 shows one or more eye/face tracking IR light sources 1305 which project IR light on the eye for purposes of eye/face tracking, where the IR light projected by the one or more eye/face tracking IR light sources 1305 is linearly-polarized according to examples of the present disclosure, as described and discussed herein. One or more polarization-sensitive eye/face tracking IR light sensors 1315 are disposed to receive reflections of IR light from the eye, where the one or more polarization-sensitive eye/face tracking IR light sensors 1315 may be implemented so as to be polarization-sensitive according to examples of the present disclosure, as described and discussed herein. The one or more polarization-sensitive eye/face tracking IR light sensors 1315 are communicatively connected to one or more controller(s)/processor(s) 1330, where the one or more controller(s)/processor(s) 1330 may include and/or may be communicatively connected to a non-transitory computer-readable storage media 1335 which stores instructions executable by the one or more controller(s)/processor(s) 1330. As used herein, “media” should be understood as the term is used in typical English parlance, i.e., including both the singular (“medium”) and the plural (“media”). In some examples, such stored executable instructions may cause the one or more controller(s)/processor(s) 1330 to perform any of the functions described herein and/or to control any of the components described herein, according to examples of the present disclosure.

In FIG. 13, the one or more polarization-sensitive eye/face tracking IR light sensors 1315 create electronic signals corresponding to the received reflections of IR light from the eye, and transmit those electronic signals to the one or more controller(s)/processor(s). The one or more controller(s)/processor(s) 1330 receives those electronic signals and performs functions related to and/or corresponding to blocks 1331, 1332, 1334, 1336, and 1338 by executing instructions stored in the non-transitory computer-readable storage media 1335. Some of the processes indicated by the blocks 1331, 1332, 1334, 1336, and 1338 in FIG. 13 may overlap, occur substantially simultaneously, and/or be continually repeated, and, moreover, the blocks may be performed by different processing components.

At block 1331, a 2D image with polarization data corresponding to the reflections of IR light from the eye received by the one or more polarization-sensitive eye/face tracking IR light sensors 1315 may be provided. In some examples, the one or more polarization-sensitive eye/face tracking IR light sensors 1315 may be one or more cameras and/or imaging sensors, which capture the 2D image with polarization data and provide it to the one or more controller(s)/processor(s) 1330. In some examples, the one or more controller(s)/processor(s) 1330 may form the 2D image with polarization data using raw data in the form of the electronic signals transmitted by the one or more polarization-sensitive eye/face tracking IR light sensors 1315.

At block 1332, the one or more controller(s)/processor(s) 1330 may compute polarization metrics of the pixels in the 2D image. In some examples, the angle of linear polarization (AOLP) and/or the degree of linear polarization (DOLP) may be computed in block 1332. In some examples, further metrics may be computed at block 1332, including, but not limited to, the intensity, the spatial properties, and other properties of the received IR light, as would be understood by one of ordinary skill in the art.

At block 1334, the one or more controller(s)/processor(s) 1330 may segment the 2D image using at least the polarization metrics computed in block 1332. In some examples, the segments may be identified, isolated, and/or separated by the one or more controller(s)/processor(s) 1330 in block 1334 in substantially the same manner as described in reference to block 1240 of FIG. 12.

At block 1336, the one or more controller(s)/processor(s) 1330 may compute a light origin probability map using the segmented 2D image from block 1334. In some examples, the one or more controller(s)/processor(s) 1330 may compute the light origin probability map in substantially the same manner as described in reference to block 1250 of FIG. 12.

At block 1338, the one or more controller(s)/processor(s) 1330 may reduce, mitigate, and/or eliminate stray light and/or the effects of stray light in the 2D image using the light origin probability map computed in block 1336. In some examples, the one or more controller(s)/processor(s) 1330 may reduce, mitigate, and/or eliminate stray light and/or the effects of stray light in the 2D image using the light origin probability map computed in block 1336 in substantially the same manner as described in reference to block 1260 of FIG. 12. Once the stray light and/or the effects of stray light are reduced, mitigated, and/or eliminated in the 2D image using the light origin probability map in block 1338, eye/face tracking may be more efficiently performed using the 2D image.

In some examples, the one or more eye/face tracking IR light sources 1305 may include any number and/or combination of active/passive components, in any suitable location and/or disposition, as would be understood by one of ordinary skill in the art, including, but not limited to, any type of IR light source and any type of polarization element to linearly-polarize the IR light (which may, or may not, be integrated into the IR light source itself). In some examples, the one or more eye/face tracking IR light sources 1305 may include any one or more of the linearly-polarized IR light sources 605a/605b, 705a/705b, 805a/805b, 905a/905b, and/or 1003x/1003y of FIGS. 6, 7, 8, 9, and 10A, respectively, and/or any one or more of the IR projectors 405 in FIGS. 4A-4C.

In some examples, the one or more polarization-sensitive eye/face tracking IR light sensors 1315 may include any number and/or combination of active/passive components, in any suitable location and/or disposition, as would be understood by one of ordinary skill in the art, including, but not limited to, any one or more of a camera, imaging sensor, and/or non-imaging sensor suitable for eye/face tracking, as described herein and/or as would be known to one of ordinary skill in the art. In some examples, the one or more polarization-sensitive eye/face tracking IR light sensors 1315 may include one or more IR sensors and one or more separate and/or integrated polarization elements to implement a combination of components which is effectively polarization-sensitive. In some examples, the one or more polarization-sensitive eye/face tracking IR light sensors 1315 may include any of the one or more eye/face tracking IR sensors 615, 715, 815, 915, and/or 1015A (and/or 1016A) in any of FIGS. 6, 7, 8, 9, and/or 10A, respectively; any of the eye/face tracking camera(s) 406, 426, and/or 436 in FIGS. 4A, 4B, and/or 4C, respectively; the eye/face tracking unit 130 and/or eye/face tracking module 118 in FIG. 1; any other sensing component described in Sect. I; and/or any other suitable sensing component, as would be understood by one of ordinary skill in the art.

In some examples, the one or more controller(s)/processor(s) 1330 may may control and/or be communicatively connected to any of the one or more eye/face tracking IR light sources 1305, the one or more polarization-sensitive eye/face tracking IR sensors 1315, and/or any other components of a near-eye device not shown in FIG. 13, as would be understood by one of ordinary skill in the art. In some examples, the one or more controller(s)/processor(s) 1330 may be one or more of the eye/face tracking unit 130 and/or eye/face tracking module 118 in FIG. 1 as described above, and/or any other processing or controlling module which may be used for eye/face tracking operations in a near-eye device, as would be understood by one of ordinary skill in the art. As discussed above, the one or more controller(s)/processor(s) 1330 may include the non-transitory computer-readable storage media 1335 which stores instructions executable by the one or more controller(s)/processor(s) 1330 to perform any of the functions described herein and/or to control any of the components described herein, according to examples of the present disclosure.

In some examples, the one or more controller(s)/processor(s) 1330 may include a general purpose single- and/or multi-chip processor, a single- and/or multi-core processor, a digital signal processor (DSP), an application specific integrated circuit (ASIC), a field programmable gate array (FPGA), or other programmable logic device, discrete gate or transistor logic, discrete hardware components, and/or any combination thereof suitable to perform the functions described herein. A general purpose processor may be any conventional processor, microprocessor, controller, microcontroller, and/or state machine. In some examples, the one or more controller(s)/processor(s) 1330 may include any of the eye/face tracking unit 130 and/or eye/face tracking module 118 in FIG. 1; the one or more controllers 430A, 430B, and/or 430C in FIGS. 4A, 4B, and/or 4C, respectively; the one or more controllers 630, 730, 830, 930, and/or 1030 in any of FIGS. 6, 7, 8, 9, and/or 10A, respectively; the one or more processors 633, 733, 833, 933, and/or 1033 in any of FIGS. 6, 7, 8, 9, and/or 10A, respectively; any other one or more processing components described in Sect. I; and/or any other suitable one or more processing components, as would be understood by one of ordinary skill in the art, in light of the present disclosure.

In some examples, the non-transitory computer-readable storage media 1335 may include one or more components (e.g., random access memory (RAM), read-only memory (ROM), flash or solid state memory, hard disk storage, etc.) for storing data and/or computer-executable instructions for completing and/or facilitating the processing and storage functions described herein. In some examples, the memory/storage may be volatile and/or non-volatile memory, and may include database components, object code components, script components, or any other type of information structure suitable for implementing the various activities and storage functions described herein. In some examples, the non-transitory computer-readable storage media 1335 may include any one or more of the memory 435C in FIG. 4C; the one or more memories 635, 735, 835, 935, and/or 1035 in any of FIGS. 6, 7, 8, 9, and/or 10A, respectively; any other one or more memory storage components described in Sect. I; and/or any other suitable one or more memory storage components, as would be understood by one of ordinary skill in the art, in light of the present disclosure.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

Generally speaking, any one or more of the components and/or functionalities described herein may be implemented by hardware, software, and/or any combination thereof, according to examples of the present disclosure. In some examples, the components and/or functionalities may be implemented by any type of application, program, library, script, task, service, process, and/or any type or form of executable instructions executed on hardware such as circuitry that may include digital and/or analog elements (e.g., one or more transistors, logic gates, registers, memory devices, resistive elements, conductive elements, capacitive elements, and/or the like, as would be understood by one of ordinary skill in the art). In some examples, the hardware and data processing components used to implement the various processes, operations, logic, and circuitry described in connection with the examples described herein may be implemented with a general purpose single- and/or multi-chip processor, a single- and/or multi-core processor, a digital signal processor (DSP), an application specific integrated circuit (ASIC), a field programmable gate array (FPGA), or other programmable logic device, discrete gate or transistor logic, discrete hardware components, and/or any combination thereof suitable to perform the functions described herein. A general purpose processor may be any conventional processor, microprocessor, controller, microcontroller, and/or state machine. In some examples, the memory/storage may include one or more components (e.g., random access memory (RAM), read-only memory (ROM), flash or solid state memory, hard disk storage, etc.) for storing data and/or computer-executable instructions for completing and/or facilitating the processing and storage functions described herein. In some examples, the memory/storage may be volatile and/or non-volatile memory, and may include database components, object code components, script components, or any other type of information structure suitable for implementing the various activities and storage functions described herein.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A near-eye device, comprising:
a linearly-polarized infrared (IR) light source to project linearly-polarized IR light onto an eye;
a polarization-sensitive IR light sensor to receive IR light, including projected linearly-polarized eye/face tracking IR light reflected back from the eye, and to sense a polarization state of the received IR light; and
a controller to receive and process the received IR light and the sensed polarization state of the received IR light, said controller comprising a processor and a non-transitory computer-readable memory storing instructions to:
compute polarization metrics for pixels in a two-dimensional (2D) image formed from the received IR light using the sensed polarization state of the received IR light;
compute a light origin probability map using the computed polarization metrics;
reduce stray light in the 2D image using the computed light origin probability map, wherein stray light comprises any IR light not originating from the linearly-polarized IR light source; and
using the 2D image with reduced stray light to perform eye/face tracking.

2. The near-eye device of claim 1, further comprising:
an IR filter to minimize stray light in the IR light received by the polarization-sensitive IR light sensor.

3. The near-eye device of claim 2, wherein the IR filter comprises at least one of:
an in-frame IR filter integrated into a frame of the near-eye device;
an in-lens IR filter integrated into a lens of the near-eye device; or
a coupling IR filter disposed adjacent to a coupling of a waveguide of the near-eye device.

4. The near-eye device of claim 1, wherein the polarization-sensitive IR light sensor is disposed behind a lens of the near-eye device.

5. The near-eye device of claim 1, wherein the polarization-sensitive IR light sensor comprises at least one of a camera, an imaging sensor, or a non-imaging sensor.

6. The near-eye device of claim 1, wherein the polarization-sensitive IR light sensor comprises a polarization element which has a polarization state orthogonal to a polarization state of a stray light source.

7. The near-eye device of claim 1, wherein polarization-sensitive IR light sensor comprises:
a linear polarization filter to filter the received IR light, wherein the linear polarization filter has a polarization state orthogonal to a polarization state of stray light reflected from any optics in the near-eye device; and
a grayscale IR camera to capture the filtered received IR light, wherein the linear polarization filter suppresses the stray light reflected from any optics in the near-eye device in the captured filtered reflection.

8. The near-eye device of claim 1, wherein polarization-sensitive IR light sensor comprises:
an active polarization rotator to switch between polarization states while filtering the received IR light; and
an IR light sensor to capture successive images of the filtered received IR light at each polarization state of the active polarization rotator.

9. The near-eye device of claim 1, further comprising:
a display screen; and
an optical stack between the display screen and the eye.

10. The near-eye device of claim 9, wherein the polarization-sensitive IR light sensor is disposed between the display screen and the optical stack.

11. The near-eye device of claim 9, wherein the linearly-polarized IR light source is disposed in the optical stack.

12. A method for stray light reduction for an eye/face tracking system in a near-eye device, comprising:
projecting, by an infrared (IR) light source of the near-eye device, linearly-polarized IR light onto an eye;
receiving and sensing, by an IR light sensor of the near-eye device, IR light and a polarization state of the received IR light, wherein the received IR light comprises projected linearly-polarized eye/face tracking IR light reflected back from the eye;
computing, by a processor of the near-eye device, polarization metrics of pixels in a two-dimensional (2D) image formed from the received IR light using the sensed polarization state of the received IR light;
computing, by the processor, a light origin probability map using the computed polarization metrics;
reducing, by the processor, stray light in the 2D image using the computed light origin probability map, wherein stray light comprises any reflected IR light not originating from the projected linearly-polarized IR light; and
performing, by the processor, eye/face tracking using the 2D image with reduced stray light.

13. The method of claim 12, wherein the computing, by the processor of the near-eye device, polarization metrics of pixels in the 2D image formed from the received IR light using the sensed polarization state of the received IR light, comprises:
computing at least one of the angle of linear polarization (AOLP) or the degree of linear polarization (DOLP) of pixels in the 2D image.

14. The method of claim 12, further comprising:
computing, by the processor, other light metrics of pixels in the 2D image formed from the received IR light,
wherein the computing, by the processor, of the light origin probability map also uses the computed other light metrics.

15. The method of claim 12, further comprising:
segmenting, by the processor, the 2D image formed from the received IR light using the computed polarization metrics,
wherein the computing, by the processor, of the light origin probability map uses the segmented 2D image.

16. The method of claim 12, wherein the receiving and sensing, by the IR light sensor of the near-eye device, the IR light and the polarization state of the received IR light comprises:
capturing the 2D image formed from the received IR light.

17. The method of claim 12, further comprising:
forming, by the processor, the 2D image from the received IR light.

18. The method of claim 12, wherein the projected linearly-polarized IR light passes through an optical stack of the near-eye device to reach the eye, and a reflection of the projected linearly-polarized IR light from the eye passes back through the optical stack to reach the IR light sensor.

19. A near-eye augmented reality/virtual reality (AR/VR) display device, comprising:
a display screen to display AR/VR content;
an optical stack through which the AR/VR content is displayed to an eye, said optical stack comprising:
an eye/face tracking infrared (IR) light source to project linearly-polarized eye/face tracking IR light onto the eye;
a polarization-sensitive eye/face tracking IR light sensor to:
receive IR light;
filter the received IR light by using a polarization state of the received IR light to pass through any projected linearly-polarized eye/face tracking IR light reflected back from the eye in the received IR light;
filter the received IR light by using the polarization state of the received IR light to reduce stray light in the received IR light; and
transmit electronic signals corresponding to an IR light image of the filtered received IR light; and
an eye/face tracking controller to receive and process the transmitted electronic signals corresponding to the IR light image of the filtered received IR light, said eye/face tracking controller comprising a processor and a non-transitory computer-readable memory storing instructions to perform eye/face tracking using the transmitted electronic signals corresponding to the IR light image of the filtered received IR light.

20. The near-eye AR/VR display device of claim 19, further comprising:
an IR filter to minimize stray light in the IR light received by the polarization-sensitive eye/face tracking IR light sensor, wherein the IR filter comprises at least one of:
an in-frame IR filter integrated into a frame of the near-eye AR/VR display device;
an in-lens IR filter integrated into a lens of the near-eye AR/VR display device; or
a coupling IR filter disposed adjacent to a coupling of a waveguide of the near-eye AR/VR display device.
